(19) United States
(12) Patent Application Publication
(10) Pub. No.: US 2026/0269899 A1
(43) Pub. Date: Sep. 10, 2026

(54) TERMINAL, RADIO COMMUNICATION METHOD, AND BASE STATION

(71) Applicant: NTT DOCOMO, INC., Tokyo (JP)

(72) Inventors: Haruhi Echigo, Chiyoda-ku, Tokyo (JP); Hiroki Harada, Chiyoda-ku, Tokyo (JP); Liu Liu, Beijing (CN)

(73) Assignee: NTT DOCOMO, INC., Tokyo (JP)

(21) Appl. No.: 18/876,429

(22) PCT Filed: Jul. 1, 2022
(86) PCT No.: PCT/JP2022/026511

§ 371 Date: Dec. 18, 2024

(51) Int. Cl. H04B 7/06; H04W 24/08

(52) U.S. Cl. CPC H04B 7/0626; H04W 24/08

(57) ABSTRACT

A terminal according to one aspect of the present disclosure includes a receiving section that receives, for artificial intelligence (AI)-based channel state information (CSI) feedback, configuration information for performance monitoring, and a control section that controls the performance monitoring. According to an aspect of the present disclosure, preferable overhead reduction/channel estimation/resource use can be achieved.

### TECHNICAL FIELD

The present disclosure relates to a terminal, a radio communication method, and a base station in next-generation mobile communication systems.

### BACKGROUND ART

In a Universal Mobile Telecommunications System (UMTS) network, the specifications of Long-Term Evolution (LTE) have been drafted for the purpose of further increasing high speed data rates, providing lower latency and so on (see Non-Patent Literature 1). In addition, for the purpose of further high capacity, advancement and the like of the LTE (Third Generation Partnership Project (3GPP (registered trademark)) Release (Rel.) 8 and Rel. 9), the specifications of LTE-Advanced (3GPP Rel. 10 to Rel. 14) have been drafted.

Successor systems of LTE (for example, also referred to as “5th generation mobile communication system (5G),” “5G+ (plus),” “6th generation mobile communication system (6G),” “New Radio (NR),” “3GPP Rel. 15 (or later versions),” and so on) are also under study.

### CITATION LIST

### Non-Patent Literature

Non-Patent Literature 1:3GPP TS 36.300 V 8.12.0 “Evolved Universal Terrestrial Radio Access (E-UTRA) and Evolved Universal Terrestrial Radio Access Network (E-UTRAN); Overall description; Stage 2 (Release 8),” April, 2010

### SUMMARY OF INVENTION

### Technical Problem

For future radio communication technologies, it is studied to utilize the artificial intelligence (AI) technology, such as machine learning (ML), for control, management, and the like of networks/devices.

As a use case for utilization of an AI model, channel state information (CSI) compression using a two-sided AI model is under study. Such a CSI compression method may be referred to as AI-based CSI feedback, and may be implemented, for example, by using an autoencoder.

Incidentally, monitoring of performance of an AI model is under study. The AI model performance monitoring may be performed in a terminal (user terminal, User Equipment (UE)) or in a base station (BS). However, regarding the AI-based CSI feedback, progress has not yet been made on a study of concrete life cycle management of the performance monitoring in the UE/BS.

Unless a method for implementing the performance monitoring is appropriately defined, appropriate overhead reduction/highly accurate channel estimation/highly efficient resource use cannot be achieved, which may suppress improvement of communication throughput/communication quality.

Thus, an object of the present disclosure is to provide a terminal, a radio communication method, and a base station capable of achieving preferable overhead reduction/channel estimation/resource use.

### Solution to Problem

A terminal according to one aspect of the present disclosure includes a receiving section that receives, for artificial intelligence (AI)-based channel state information (CSI) feedback, configuration information for performance monitoring, and a control section that controls the performance monitoring.

### Advantageous Effects of Invention

According to an aspect of the present disclosure, preferable overhead reduction/channel estimation/resource use can be achieved.

### BRIEF DESCRIPTION OF DRAWINGS

FIG. 1 is a diagram to show an example of an AI model management framework.

FIG. 2 is a diagram to show an example of CSI feedback using an encoder/decoder.

FIG. 3 is a diagram to show an example of a life cycle management framework for performance monitoring in a UE according to one embodiment.

FIG. 4 is a diagram to show an example of a life cycle management framework for performance monitoring in a BS according to one embodiment.

FIG. 5 is a diagram to show an example of performance monitoring in Embodiment 1.1.

FIG. 6 is a diagram to show an example of performance monitoring in Embodiment 1.2.

FIGS. 7A and 7B are diagrams to show examples of model evaluation in a second embodiment.

FIG. 8 is a diagram to show an example of model evaluation in the second embodiment.

FIG. 9 is a diagram to show an example of performance monitoring in a sixth embodiment.

FIG. 10 is a diagram to show an example of a schematic structure of a radio communication system according to one embodiment.

FIG. 11 is a diagram to show an example of a structure of a base station according to one embodiment.

FIG. 12 is a diagram to show an example of a structure of a user terminal according to one embodiment.

FIG. 13 is a diagram to show an example of a hardware structure of the base station and the user terminal according to one embodiment.

FIG. 14 is a diagram to show an example of a vehicle according to one embodiment.

### DESCRIPTION OF EMBODIMENTS

### Application of Artificial Intelligence (AI) Technology to Radio Communication

For future radio communication technologies, a study is underway to utilize the AI technology, such as machine learning (ML), for control, management, and the like of networks/devices.

For example, it is studied that a terminal (user terminal, User Equipment (UE))/base station (BS) utilizes the AI technology for improvement in channel state information (CSI) feedback (for example, overhead reduction, accuracy enhancement, prediction), enhancement in beam management (for example, accuracy enhancement, prediction in time/spatial domain), enhancement in location measurement (for example, location estimation/prediction enhancement), and the like.

An AI model may output at least one piece of information among an estimated value, a predicted value, a selected operation, classification, and the like, based on input information. The UE/BS may input channel state information, a reference signal measurement value, and the like to the AI model and output highly accurate channel state information/measured value/beam selection/location, future channel state information/radio link quality, and the like.

Note that, in the present disclosure, AI may be interpreted as an object (also referred to as a target, data, function, program, and the like) having (implementing) at least one of the following features:
estimation based on observed or collected information,
selection based on observed or collected information, and
prediction based on observed or collected information.

In the present disclosure, estimation, prediction, and inference may be interchangeably interpreted. In the present disclosure, “estimate,” “predict,” and “infer” may be interchangeably interpreted.

In the present disclosure, the object may be, for example, an apparatus, a device, or the like, such as a UE or a BS. In the present disclosure, the object may correspond to a program/model/entity operating in the apparatus.

Note that, in the present disclosure, the AI model may be interpreted as an object having (implementing) at least one of the following features:
feeding information to thereby generate an estimated value,
feeding information to thereby predict an estimated value,
feeding information to thereby find a feature, and
feeding information to thereby select an operation.

In the present disclosure, the AI model may mean a data-driven algorithm that applies the AI technology to generate an output set, based on an input set.

In the present disclosure, an AI model, a model, an ML model, predictive analytics, a predictive analytics model, a tool, an autoencoder, an encoder, a decoder, a neural network model, an AI algorithm, a scheme, and the like may be interchangeably interpreted. The AI model may be derived by using at least one of regression analysis (for example, linear regression analysis, multiple regression analysis, logistic regression analysis), support vector machine, random forest, neural network, deep learning, and the like.

In the present disclosure, the autoencoder may be interchangeably interpreted as an arbitrary autoencoder such as a stacked autoencoder and a convolutional autoencoder. The encoder/decoder in the present disclosure may adopt a model of Residual Network (ResNet), DenseNet, RefineNet, or the like.

In the present disclosure, an encoder, encoding, encode/encoded, modification/change/control using an encoder, compressing, compress/compressed, generating, generate/generated, and the like may be interchangeably interpreted.

In the present disclosure, a decoder, decoding, decode/decoded, modification/change/control using a decoder, decompressing, decompress/decompressed, reconstructing, reconstruct/reconstructed, and the like may be interchangeably interpreted.

In the present disclosure, a layer (for an AI model) may be interchangeably interpreted as a layer (input layer, intermediate layer, or the like) used in an AI model. The layer in the present disclosure may correspond to at least one of an input layer, an intermediated layer, an output layer, a batch normalization layer, a convolutional layer, an activation layer, a dense layer, a normalization layer, a pooling layer, an attention layer, a dropout layer, a fully-connected layer, and the like.

In the present disclosure, examples of a method for training the AI model may include supervised learning, unsupervised learning, reinforcement learning, and federated learning. The supervised learning may mean processing for training a model, based on input and a corresponding label. The unsupervised learning may mean processing for training a model without labeled data. The reinforcement learning may mean processing for training a model in an environment where models interact with each other, based on an input (in other words, a state) and a feedback signal (in other words, compensation) generated from an output of the model (in other words, action).

In the present disclosure, generation, computation, derivation, and the like may be interchangeably interpreted. In the present disclosure, “perform,” “manage,” “operate,” “carry out,” and the like may be interchangeably interpreted. In the present disclosure, training, learning, update, retraining, and the like may be interchangeably interpreted. In the present disclosure, inference, after-training, substantial use, actual use, and the like may be interchangeably interpreted. In the present disclosure, a signal and a signal/channel may be interchangeably interpreted.

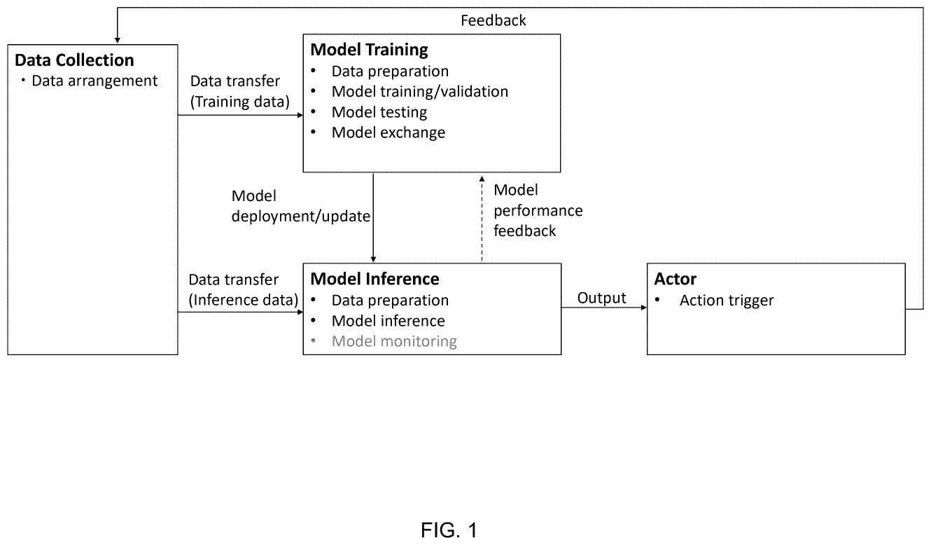

FIG. 1 is a diagram to show an example of an AI model management framework. In the present example, stages related to an AI model are shown using blocks. The present example is also expressed as AI model life cycle management.

A data collection stage corresponds to a stage to collect data for generating/updating the AI model. The data collection stage may include data arrangement (for example, determining which data is forwarded for model training/model inference), data forwarding (for example, forwarding data to an entity (for example, UE, gNB) performing model training/model inference), and the like.

Note that the data collection may mean processing in which data is collected by a network node, a management entity, or a UE for the purpose of AI model training/data analysis/inference. In the present disclosure, the processing and procedure may be interchangeably interpreted.

A model training stage is to perform the model training, based on data (training data) forwarded from the collection stage. This stage may include data preparation (for example, performing pre-processing, cleaning, formatting, conversion, and the like of data), model training/validation, model testing (for example, checking whether a trained model meets a performance threshold), model exchange (for example, forwarding a model for distributed learning), model deployment/update (deploying/updating a model for an entity performing model inference), and the like.

Note that the AI model training may mean processing for training an AI model with a data-driven method and acquiring a trained AI model for inference.

AI model validation may mean sub-processing for training for evaluating quality of an AI model by using a dataset different from a dataset used for the model training. The sub-processing is useful for selection of a model parameter for generalization beyond the data set used for the model training.

AI model testing may mean sub-processing for training for evaluating performance of a final AI model by using a dataset different from the dataset used for the model training/validation. Note that, unlike the validation, the testing may not be based on subsequent model tuning.

A model inference stage is to perform model inference, based on the data (inference data) forwarded from the collection stage. This stage may include data preparation (for example, performing pre-processing, cleaning, formatting, conversion, and the like of data), model inference, model monitoring (for example, monitoring model inference performance), model performance feedback (feeding back model performance to an entity performing model training), output (providing a model output to an actor), and the like.

Note that AI model inference may mean processing for generating an output set from an input set by using a trained AI model.

A UE-side model may mean an AI model in which the inference is completely performed in a UE. A network-side model may mean an AI model in which the inference is completely performed in a network (for example, a gNB).

A one-sided model may mean a UE-side model or a network-side model. A two-sided model may mean a pair of AI models in which joint inference is performed. Here, the joint inference may include AI inference in which the inference is performed jointly over the UE and the network, and, for example, a first part of the inference may be performed first by the UE and the remaining part may be performed by the gNB (or vice versa).

AI model monitoring may mean processing for monitoring inference performance of an AI model, and may be interchangeably interpreted as model performance monitoring, performance monitoring, and the like.

Note that model registration may mean that a model is given a version identifier and is made executable by being compiled into specific hardware used in an inference stage. Model deployment may mean distributing a runtime image (or execution environment image) of a fully developed and tested model to a target (for example, a UE/gNB) in which inference is performed (or enabling the runtime image in the target).

An actor stage may include an action trigger (for example, determining whether to trigger action to another entity), feedback (for example, feeding back information required for training data/inference data/performance feedback), and the like.

Note that, for example, training of a model for mobility optimization may be performed in, for example, maintenance, operation, and administration in a network (NW) (Operation, Administration and Maintenance (Management) (OAM))/gNodeB (gNB). In the former case, interoperation, large amounts of storage, operator manageability, model flexibility (such as feature engineering) are advantageous. In the latter case, model update latency, data exchange for model deployment, and the like are advantageously not required. The inference of the model described above may be performed in the gNB, for example.

An entity performing training/inference may differ depending on a use case (in other words, an AI model function). The AI model function may include beam management, beam prediction, an autoencoder (or information compression), CSI feedback, location positioning, and the like.

For example, for AI-aided beam management based on a measurement report, the OAM/gNB may perform the model training, and the gNB may perform the model inference.

For AI-aided UE-assisted positioning, a Location Management Function (LMF) may perform the model training, and the LMF may perform the model inference.

For CSI feedback/channel estimation using an autoencoder, the OAM/gNB/UE may perform the model training, and the gNB/UE may perform the model inference (jointly).

For AI-aided beam management or AI-aided UE-based positioning based on beam measurements, the OAM/gNB/UE may perform the model training, and the UE may perform the model inference.

Note that model activation may mean enabling of an AI model for a specific function. Model deactivation may mean disabling of an AI model for a specific function. Model switching may mean that a currently active AI model for a specific function is deactivated and a different AI model can be activated.

Model transfer may mean distribution of an AI model over an air interface. This distribution may include distribution, on a reception side, of one or both of a known model structure parameter and a new model with a parameter. This distribution may include a complete model or a partial model. A model download may mean model transfer from a network to a UE. A model upload may mean model transfer from a UE to a network.

### AI-Based CSI Feedback

As a use case for utilization of an AI model, CSI compression using a two-sided AI model is under study. Such a CSI compression method may be referred to as AI-based CSI feedback, and may be implemented, for example, by using an autoencoder.

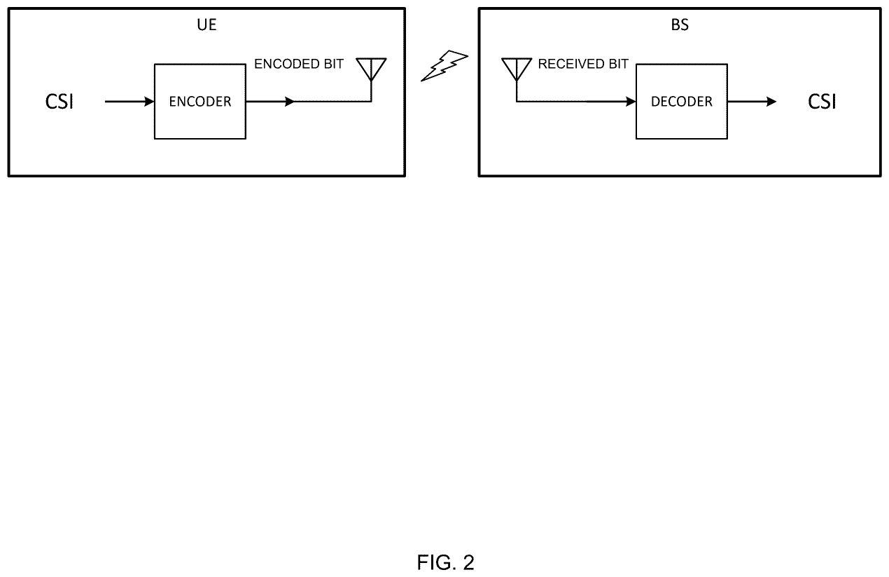

FIG. 2 is a diagram to show an example of CSI feedback using an encoder/decoder. The UE transmits, from an antenna, information (CSI feedback information) including an encoded bit output by inputting CSI to an encoder. The BS inputs the bit of the received CSI feedback information to a corresponding decoder to obtain output CSI.

The input CSI may include, for example, information on a channel coefficient (element of a channel matrix) or information on a precoding coefficient (element of a precoding matrix). In other words, the CSI may correspond to information related to a channel state in a spatial-frequency domain. Note that the input may include information other than the CSI.

Note that the CSI output from the decoder may be reconstructed CSI corresponding to the input to the encoder or may be CSI different from the input to the encoder (for example, precoding coefficient information or the like, if the input information is channel coefficient information).

Note that the encoder/decoder may include pre-processing for the input, post-processing for the output, and the like.

The encoded bit is compressed more than the input information before the encoding, and communication overhead for CSI feedback can be expected to be reduced.

Incidentally, the performance monitoring shown in FIG. 1 may be performed in the UE or in the BS. However, regarding the AI-based CSI feedback, progress has not yet been made on a study of concrete life cycle management of the performance monitoring in the UE/BS.

Unless a method for implementing the performance monitoring is appropriately defined, appropriate overhead reduction/highly accurate channel estimation/highly efficient resource use cannot be achieved, which may suppress improvement of communication throughput/communication quality.

Thus, the inventors of the present invention came up with the idea of a preferable method for implementing performance monitoring in a UE/BS.

Embodiments according to the present disclosure will be described in detail with reference to the drawings as follows. The radio communication methods according to respective embodiments may each be employed individually, or may be employed in combination.

In the present disclosure, “A/B” and “at least one of A and B” may be interchangeably interpreted. In the present disclosure, “A/B/C” may refer to “at least one of A, B, and C.”

In the present disclosure, “activate,” “deactivate,” “indicate,” “select,” “configure,” “update,” “determine,” and the like may be interchangeably interpreted. In the present disclosure, “support,” “control,” “controllable,” “operate,” “operable,” and the like may be interchangeably interpreted.

In the present disclosure, radio resource control (RRC), an RRC parameter, an RRC message, a higher layer parameter, a field, an information element (IE), a configuration, and the like may be interchangeably interpreted. In the present disclosure, a Medium Access Control control element (MAC Control Element (CE)), an update command, an activation/deactivation command, and the like may be interchangeably interpreted.

In the present disclosure, the higher layer signaling may be, for example, any one or combinations of Radio Resource Control (RRC) signaling, Medium Access Control (MAC) signaling, broadcast information, and the like.

In the present disclosure, the MAC signaling may use, for example, a MAC control element (MAC CE), a MAC Protocol Data Unit (PDU), or the like. The broadcast information may be, for example, a master information block (MIB), a system information block (SIB), minimum system information (Remaining Minimum System Information (RMSI)), other system information (OSI), or the like.

In the present disclosure, physical layer signaling may be, for example, downlink control information (DCI), uplink control information (UCI), or the like.

In the present disclosure, an index, an identifier (ID), an indicator, a resource ID, and the like may be interchangeably interpreted. In the present disclosure, a sequence, a list, a set, a group, a cluster, a subset, and the like may be interchangeably interpreted.

In the present disclosure, a panel, a UE panel, a panel group, a beam, a beam group, a precoder, an Uplink (UL) transmission entity, a transmission/reception point (TRP), a base station, spatial relation information (SRI), a spatial relation, an SRS resource indicator (SRI), a control resource set (CORESET), a Physical Downlink Shared Channel (PDSCH), a codeword (CW), a transport block (TB), a reference signal (RS), an antenna port (for example, a demodulation reference signal (DMRS) port), an antenna port group (for example, a DMRS port group), a group (for example, a spatial relation group, a code division multiplexing (CDM) group, a reference signal group, a CORESET group, a Physical Uplink Control Channel (PUCCH) group, a PUCCH resource group), a resource (for example, a reference signal resource, an SRS resource), a resource set (for example, a reference signal resource set), a CORESET pool, a downlink Transmission Configuration Indication state (TCI state) (DL TCI state), an uplink TCI state (UL TCI state), a unified TCI state, a common TCI state, quasi-co-location (QCL), QCL assumption, and the like may be interchangeably interpreted.

In the present disclosure, a CSI-RS, a non zero power (NZP) CSI-RS, a zero power (ZP) CSI-RS, and CSI interference measurement (CSI-IM) may be interchangeably interpreted. The CSI-RS may include other reference signals.

In the present disclosure, a measured/reported RS may mean an RS measured/reported for CSI reporting.

In the present disclosure, timing, a time point, a time, a slot, a sub-slot, a symbol, a subframe, and the like may be interchangeably interpreted.

In the present disclosure, a direction, an axis, a dimension, a domain, a polarized wave, a polarization component, and the like may be interchangeably interpreted.

In the present disclosure, the RS may be a CSI-RS, an SS/PBCH block (SS block (SSB)), or the like, for example. An RS index may be a CSI-RS resource indicator (CRI), an SS/PBCH block resource indicator (SSBRI), or the like.

In the present disclosure, the channel measurement/estimation may be performed by using at least one of a channel state information reference signal (CSI-RS), a synchronization signal (SS), a synchronization signal/broadcast channel (Synchronization Signal/Physical Broadcast Channel (SS/PBCH)) block, a demodulation reference signal (DMRS), a reference signal for measurement (Sounding Reference Signal (SRS)), and the like, for example.

In the present disclosure, the CSI may include at least one of a channel quality indicator (CQI), a precoding matrix indicator (PMI), a CSI-RS resource indicator (CRI), an SS/PBCH block resource indicator (SSBRI), a layer indicator (LI), a rank indicator (RI), L1-RSRP (reference signal received power in Layer 1 (Layer 1 Reference Signal Received Power)), L1-RSRQ (Reference Signal Received Quality), an L1-SINR (Signal to Interference plus Noise Ratio), an L1-SNR (Signal to Noise Ratio), information related to a channel matrix (or channel coefficient), information related to a precoding matrix (or precoding coefficient), and the like.

In the present disclosure, UCI, CSI reporting, CSI feedback, feedback information, feedback bit, a CSI feedback method, a CSI feedback scheme, and the like may be interchangeably interpreted. In the present disclosure, a bit, a bit string, a bit sequence, a sequence, a value, information, a value obtained from a bit, information obtained from a bit, and the like may be interchangeably interpreted.

In the present disclosure, “model/non-AI-based CSI feedback” may be interchangeably interpreted as a model, a CSI feedback method, a CSI feedback scheme, and the like.

In the following embodiments, description will be given of an AI model related to UE-BS communication, and hence related subjects are a UE and a BS. However, application of each of the embodiments of the present disclosure is not limited to this. For example, for communication between different subjects (for example, UE-UE communication), the UE and the BS in the following embodiments may be interpreted as a first UE and a second UE. In other words, the UE, the BS, and the like in the present disclosure may be interpreted as any UE/BS.

### Radio Communication Method

Regarding the AI-based CSI feedback, respective steps in a life cycle management framework for performance monitoring in a UE/BS will be described below.

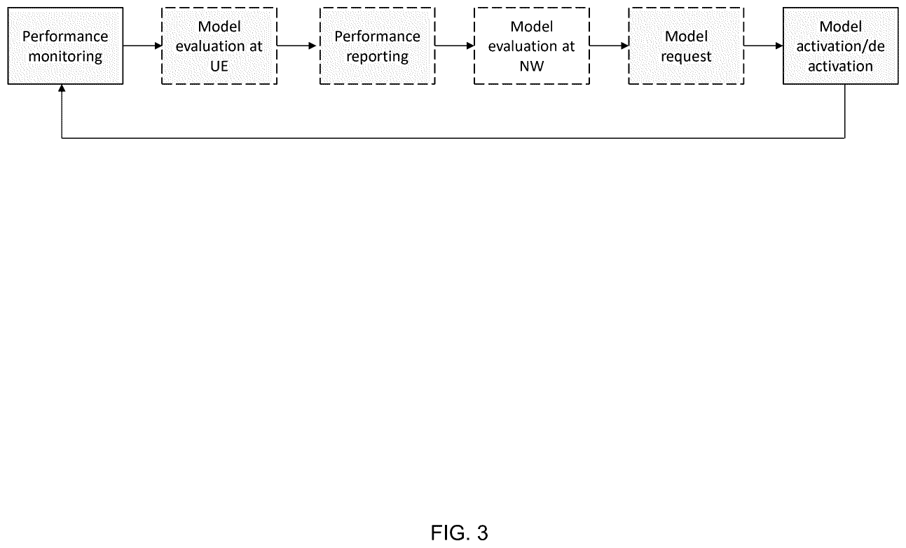

FIG. 3 is a diagram to show an example of the life cycle management framework for the performance monitoring in the UE according to one embodiment.

In a performance monitoring step, the UE monitors performance of a model and a fallback scheme (non-AI-based CSI feedback).

In a model evaluation step in the UE, the UE evaluates performance of the monitored/reported model and fallback scheme (non-AI-based CSI feedback).

In a performance reporting step, the UE reports the monitored performance to a NW.

In a model evaluation step in the NW, the NW evaluates performance of the reported model and fallback scheme.

In a model request step, the UE transmits, to the NW, a request related to which model is to be applied or whether the fallback scheme is to be applied.

In a model activation/deactivation step, which scheme (model) is to be activated may be indicated for the UE. The UE may activate a certain model or fallback scheme.

Note that some of the illustrated steps (for example, steps represented by broken lines) may be performed as needed.

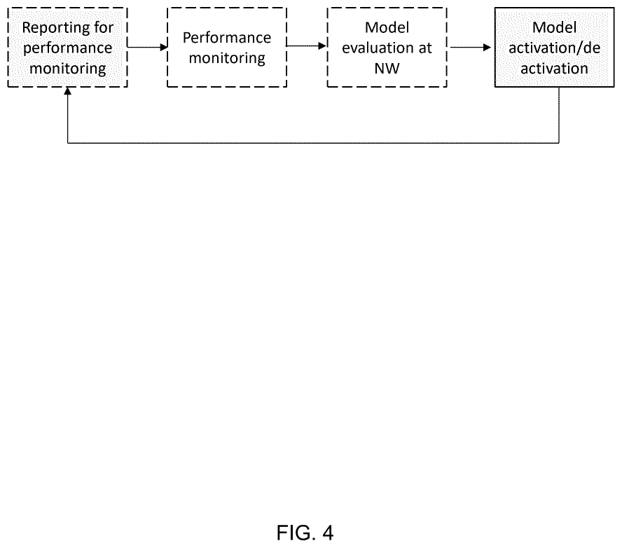

FIG. 4 is a diagram to show an example of the life cycle management framework for the performance monitoring in the BS according to one embodiment.

In a step of reporting for performance monitoring, the UE reports information for performance monitoring in the NW (BS).

In a performance monitoring step in the NW, the NW monitors performance of a model and a fallback scheme (non-AI-based CSI feedback).

In a model evaluation step in the NW, the NW evaluates performance of the model and fallback scheme.

In a model activation/deactivation step, which scheme (model) is to be activated may be indicated for the UE. The UE may activate a certain model or fallback scheme.

Note that some of the illustrated steps (for example, steps represented by broken lines) may be performed as needed.

Details of the steps shown in FIGS. 3 and 4 will be described in respective embodiments described below.

### First Embodiment

A First Embodiment Relates to Performance Monitoring in a Ue.

The UE may be notified of at least one of which performance of which AI model is to be monitored and which performance of which non-AI-based CSI feedback is to be monitored, from a network. Determination of the AI model to be monitored will be described below in variations of a fifth embodiment.

In the present disclosure, the non-AI-based CSI feedback may be referred to as a fallback scheme, and may correspond to a scheme in which the UE feeds back a CQI, a PMI, and the like fed back in an existing specification.

In the present disclosure, a model whose performance is monitored may be referred to as a monitored model. Note that a registered model (to which registration is applied)/configured model may correspond to a monitored model/activated model.

Note that the UE may be notified of a CSI-RS resource/CSI-RS resource set/CSI resource configuration/CSI report configuration for performance monitoring.

### Embodiment 1.1

In Embodiment 1.1, when both an encoder and a decoder are available in the UE, the UE may monitor real-time performance (which may be referred to as actual performance). The actual performance may mean performance of CSI computed based on an output of an AI model, the CSI being compared with target CSI.

The performance monitored in Embodiment 1.1 may be at least one of the following:
(1) Generalized Cosine Similarity (GCS)/Squared GCS (SGCS) between CSI computed based on an output of an AI model and target CSI of the AI model (for example, CSI computed based on channel measurement) (which may include expanded GCS/SGCS for layer >1),
(2) communication quality computed based on an output of an AI model, for example, a CQI satisfying a certain block error probability in assumption for specific resource allocation, and
(3) Normalized Mean Square Error (NMSE)/Mean Square Error (MSE) between the CSI calculated based on the output of the AI model and the target CSI of the AI model.

Here, in the present disclosure, the target CSI may be, for example, CSI calculated based on channel measurement, or ideal CSI. In the present disclosure, the ideal CSI may mean ideal CSI without error output from the AI model, or may mean CSI output from the AI model, corresponding to a specific input (or any input). The ideal CSI may be referred to as fixed CSI and the like.

The CSI in (1)/(3) may be at least one of a precoding matrix, one or more precoding vectors, and one or more eigenvectors. The CSI in (1)/(3) may be quantized CSI. The CSI computed based on the output of the AI model in (1)/(3) may correspond to CSI reconstructed by the AI model.

The CQI in (2) may be, for example, at least one of a broadband CQI, an average of subband CQIs, a weighted average of subband CQIs, a maximum/minimum of subband CQIs, and the like. The specific resource allocation may correspond to frequency/time resource allocation for reception of a certain channel/signal (for example, a PDSCH, a PDCCH, or a corresponding DMRS), and what type of resource allocation the specific resource allocation is (for example, the number of symbols, the number of resource blocks, and the like to be assumed) may be defined in a specification. A certain block error probability may be, for example, at least one of 0.1, 0.00001, and the like.

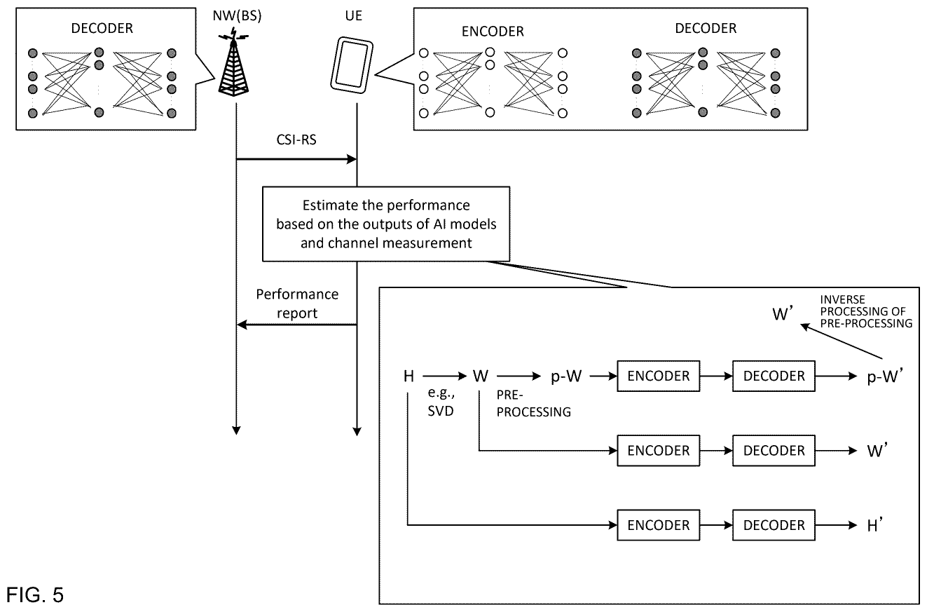

FIG. 5 is a diagram to show an example of the performance monitoring in Embodiment 1.1. In the present example, for simplicity, assume that CSI output from a decoder is reconstructed CSI corresponding to an input to the encoder. Note that a decoder included by the UE is merely provided for performance monitoring, and CSI feedback transmitted by the UE is an output of the encoder. The UE includes at least one encoder and a corresponding decoder illustrated.

In the present example, the UE performs channel measurement, based on a CSI-RS transmitted from the BS, and obtains a channel matrix H. When an input to the encoder included by the UE is H, the UE inputs the output obtained by inputting H to the encoder to the corresponding decoder and obtains a reconstructed channel matrix H′. The UE estimates the performance, based on H and H′.

Note that, when the input to the encoder included by the UE is a precoding matrix W, the UE may perform specific processing (for example, singular value decomposition (SVD)) on H to obtain W. The UE inputs the output obtained by inputting W to the encoder to the corresponding decoder and obtains a reconstructed precoding matrix W′. The UE estimates the performance, based on W and W′.

When the input to the encoder included by the UE is a precoding matrix p-W to which pre-processing (for example, inverse discrete Fourier transform (IDFT) and sampling) is applied, the UE may perform the above-described pre-processing on W described above to obtain p-W. The UE inputs the output obtained by inputting p-W to the encoder to the corresponding decoder and obtains a reconstructed precoding matrix p-W′ after the pre-processing. The UE may estimate the performance, based on p-W and p-W′, or may estimate the performance, based on W′ obtained by applying inverse processing of the pre-processing to W and p-W′.

Note that the UE may transmit a performance report to the BS as necessary.

According to Embodiment 1.1, it is possible to monitor a reliable real-time performance.

### Embodiment 1.2

In Embodiment 1.2, when an encoder is available in the UE, the UE may monitor expected performance.

The performance monitored in Embodiment 1.2 (expected performance) may be at least one of the following:
(1) expected communication quality computed based on an output of an AI model, for example, an expected CQI satisfying a certain block error probability in assumption for specific resource allocation, and
(2) expected performance of reconstructed CSI (for example, expected noise variance) compared with the target CSI.

The assumption for the specific resource allocation, the certain block error probability, and the CQI in (1) may be similar to those described for the performance in (2) in Embodiment 1.1.

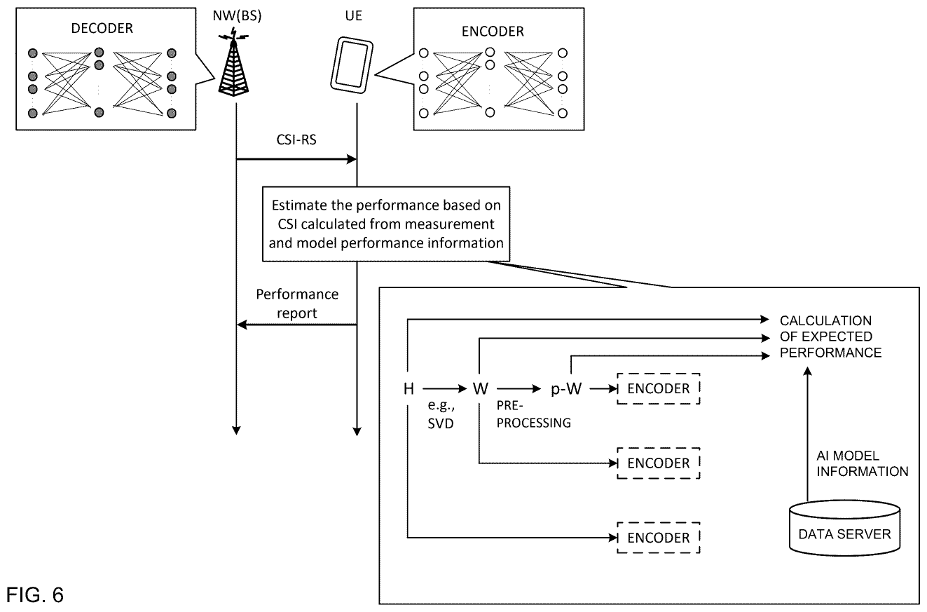

FIG. 6 is a diagram to show an example of the performance monitoring in Embodiment 1.2. Description of configuration which may be similar to that of FIG. 4 will not be repeated. The UE includes at least one illustrated encoder. In the present example, the UE does not include a decoder corresponding to the encoder.

In the present example, the UE may receive information on expected performance of an AI model corresponding to an AI model of the encoder, from a data server or a NW of a third party. The information may be included in AI model information (which will be described in the present disclosure below).

Note that, in the present disclosure, the data server may be interchangeably interpreted as a repository, an uploader, a library, a cloud server, a server simply, and the like. The data server in the present disclosure may be provided by any platform such as GitHub (registered trademark), and may be operated by any company/organization.

In the present example, the UE performs channel measurement, based on a CSI-RS transmitted from the BS, and obtains H/W/p-W corresponding to the target CSI. The UE computes (estimates) the expected performance, based on the target CSI and the above-described information on the expected performance. The UE may not operate the encoder when only performing performance monitoring.

According to Embodiment 1.2, it is possible to monitor performance even when the UE does not recognize an AI model of a decoder.

### Embodiment 1.3

In Embodiment 1.3, the UE may monitor a performance of non-AI-based CSI feedback.

For example, the UE may monitor performance for a PMI of a certain codebook type (for example, a type I codebook, a type II codebook).

The performance monitored in Embodiment 1.3 may be at least one of the following:
(1) GCS/SGCS between CSI quantized by the PMI (for example, a precoding matrix corresponding to the PMI) and target CSI of an AI model (for example, (precoding matrix corresponding to) CSI computed based on channel measurement) (which may include expanded GCS/SGCS for layer >1),
(2) communication quality based on performance expected based on the non-AI-based CSI feedback, for example, a CQI of the non-AI-based CSI feedback satisfying a certain block error probability in assumption for specific resource allocation.

For (1), for example, GCS/SGCS between a precoding matrix (or precoding vector, eigenvector, or the like) reconstructed by the PMI and a precoding matrix (or precoding vector, eigenvector, or the like) computed based on channel measurement may be monitored.

The assumption for the specific resource allocation, the certain block error probability, and the CQI in (2) may be similar to those described for the performance in (2) in Embodiment 1.1.

According to Embodiment 1.3, with combination of Embodiment 1.3 and Embodiment 1.1/1.2, the UE can preferably perform performance comparison between AI-based CSI feedback and non-AI-based CSI feedback.

According to the first embodiment described above, the UE can appropriately perform performance monitoring.

### Second Embodiment

A second embodiment relates to model evaluation in a UE.

A UE may evaluate performance of a CSI feedback method (such as the model performance described in the first embodiment, and the performance based on the non-AI-based CSI feedback), and may determine at least one of which performance is to be reported, which method is to be requested, which method is to be activated, and the like.

The UE may check (evaluate) whether one or more pieces of monitored performance satisfy at least one of the following conditions:
Condition 1: monitored performance of an active/registered/configured model or non-AI-based CSI feedback is less/greater than one monitored performance of an inactive model or non-AI-based CSI feedback (for example, another codebook type),
Condition 2: monitored performance of a registered/configured model is greater/less than one monitored performance of non-AI-based CSI feedback,
Condition 3: monitored performance of a certain monitored model (for example, active model) or non-AI-based CSI feedback is less than a threshold,
Condition 4: monitored performance of a certain monitored model (for example, inactive model) or non-AI-based CSI feedback is greater than a threshold,
Condition 5: monitored performance of a certain monitored model or non-AI-based CSI feedback has changed more than Y times since (transmission of) the last performance report, and
Condition 6: monitored performance of a certain monitored model or non-AI-based CSI feedback is less than a threshold a certain number of times or more over a certain period.

Note that, in the present disclosure, monitored performance may be interchangeably interpreted as the performance obtained by adding offset X (X is, for example, a real number) to the monitored performance. The offset X may be determined based on a factor different from pure performance (reproducibility) (for example, unmonitored performance/performance not required to be monitored). Introducing the offset enables model evaluation with comprehensive consideration of the different factor.

Here, the unmonitored performance/performance not required to be monitored may correspond to at least one of CSI feedback overhead, reliability (of a model/computed value), model complexity, power consumption for computation, and the like.

Values of X, Y, the threshold, and the like (or information related to the values) may be predefined in a specification, may be determined based on a UE capability, may be notified to the UE from the NW, or may be included in AI model information (may be determined based on a model). Information related to the values of X, Y, the threshold, and the like may be defined/notified for each model/non-AI-based CSI feedback, may be defined/notified for each group of models/non-AI-based CSI feedbacks, or may be defined/notified for AI-based CSI feedback or non-AI-based CSI feedback.

Which (or which combination) of Conditions 1 to 6 is to be checked by the UE may be defined/notified for each model/non-AI-based CSI feedback, may be defined/notified for each group of models/non-AI-based CSI feedbacks, or may be defined/notified for AI-based CSI feedback or non-AI-based CSI feedback.

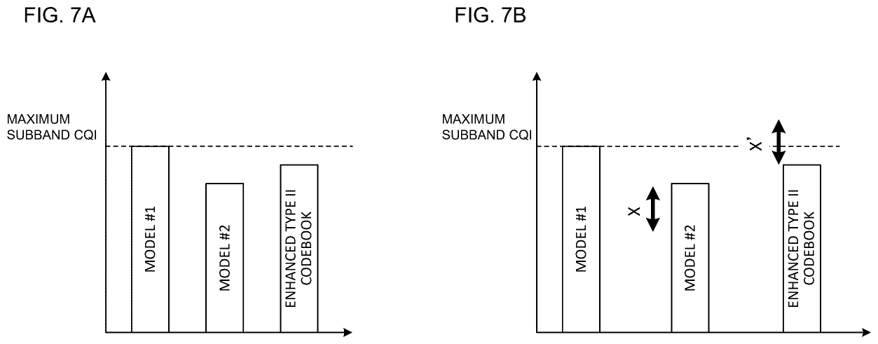

FIGS. 7A and 7B are diagrams to show examples of the model evaluation in the second embodiment. In the present example, an evaluated performance is a maximum subband CQI, and the UE compares CQIs of AI models #1 and #2 with a CQI of an enhanced type II codebook as non-AI-based CSI feedback. The UE may activate, for example, the scheme with the best performance among them.

FIG. 7A shows an example in which no offset is applied to each monitored performance. In the present example, the UE determines that monitored performance of model #1 is the largest.

FIG. 7B shows an example in which offset X (note, however, that X<0) and offset X′ (note, however, that X′>0) are applied to monitored performance of model #2 and monitored performance of the enhanced type II codebook, respectively. In the present example, the UE determines that the monitored performance of the enhanced type II codebook is the largest.

Condition 6 will be described more specifically. Condition 6 may include, for example, the following steps:
starting a timer when a first counter counts the monitored performance being less than a first value a first number of times or more,
while the timer is running, stopping the above-described timer when a second counter counts the monitored performance being greater than a second value a second number of times or more,
while the timer is running, resetting the second counter when the monitored performance is less than the first value,
resetting the first counter when the monitored performance is greater than the first value, and
evaluating that the performance of the monitored model is lower when the timer has expired.

Note that the first value may be a first threshold (thresholdₒᵤₜ), or a value that is first offset (offsetₒᵤₜ) lower than a reference value (baseline value) for a specific model/non-AI-based CSI feedback.

Note that the second value may be a second threshold (thresholdᵢₙ) or may be second offset (offsetᵢₙ) greater than the reference value (baseline value) for the specific model/non-AI-based CSI feedback.

Note that reset of the counter may mean that the counter is set to a specific value (for example, 0).

Here, the first/second threshold, the baseline value, the first/second offset, the first/second counter, granularity of the counter, and values of a time length of the timer and the like (or information related to the values) may be predefined in a specification, may be determined based on a UE capability, may be notified to the UE from the NW, or may be included in AI model information (may be determined based on a model). Information related to these values may be defined/notified for each model/non-AI-based CSI feedback, may be defined/notified for each group of models/non-AI-based CSI feedbacks, or may be defined/notified for AI-based CSI feedback or non-AI-based CSI feedback.

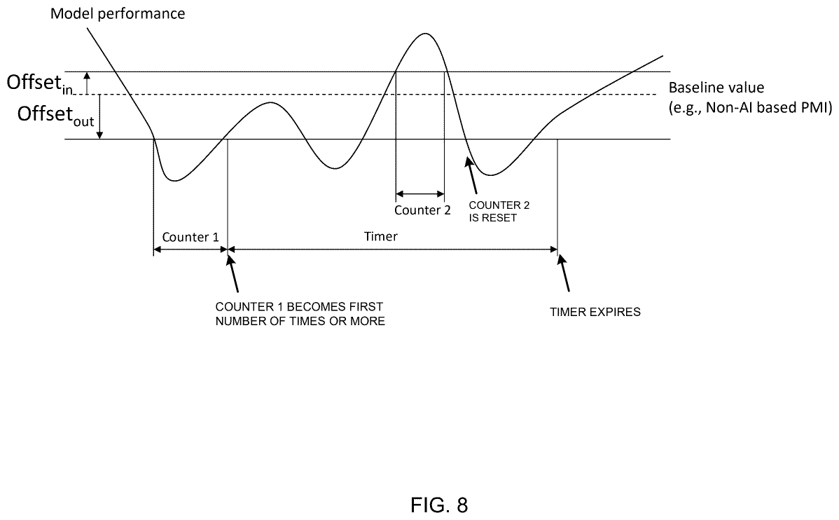

FIG. 8 is a diagram to show an example of the model evaluation in the second embodiment. In the present example, monitored performance is satisfactory at first, but the timer is started when the first counter counts the monitored performance being less than the first value a first number of times or more. Subsequently, the second counter counts the monitored performance being greater than the second value several times while the timer is running, but the second counter does not become a second number of times or more, which causes the timer to expire, thereby evaluating that the performance of this model is lower.

In the second embodiment, the UE may evaluate performance of one or more CSI feedback methods to select (determine) the top K (where K is an integer) pieces of performance for reporting/model request/model activation/model deactivation.

These K pieces of performance described above may all be selected from performance of AI-based CSI feedbacks, may all be selected from performance of non-AI-based CSI feedbacks, or may be selected from performance of AI-based CSI feedback(s) and non-AI-based CSI feedback(s).

In other words, the UE may evaluate performance of one or more CSI feedback methods to determine the top K (where K is an integer) pieces of performance from performance of AI-based CSI feedbacks and to determine the top K′ (where K′ is an integer) pieces of performance from performance of non-AI-based CSI feedbacks.

Values of K, K′, and the like (or information related to the values) may be predefined in a specification, may be determined based on a UE capability, may be notified to the UE from the NW, or may be information associated with a model (may be determined based on a model).

Note that, in the present disclosure, the UE may derive performance, based on one or more pieces of monitored performance and one or more pieces of unmonitored performances/performance not required to be monitored. In the present disclosure, monitored performance may be averaged/weighted over a certain period in evaluation/comparison. Information related to the period, the averaging/weighting method, and the like may be predefined in a specification, may be determined based on a UE capability, may be notified to the UE from the NW, or may be information associated with a model (may be determined based on a model).

According to the second embodiment described above, the UE can appropriately perform model evaluation.

### Third Embodiment

A third embodiment relates to a performance report.

### Timing of Reporting

A UE may transmit a performance report, based on information notified from a NW. For example, the UE may transmit the performance report on a periodically/semi-persistently/aperiodically scheduled uplink resource, based on RRC/MAC CE/DCI. In this case, the performance report may be included in UCI. In this case, the UE may determine a periodicity/offset of the reporting, based on the RRC/MAC CE/DCI.

The UE itself may determine a trigger related to a performance report, and may transmit the performance report when the trigger is executed. For example, the UE may transmit the performance report when the condition described in the second embodiment (for example, at least one of Conditions 1 to 6) is satisfied. In this case, the performance report may be included in a MAC CE (because the MAC CE can be transmitted when a PUSCH is scheduled).

The UE may transmit a performance report when a new model is activated/registered/configured. The UE may transmit a performance report when a timer based on a configured/specified parameter (for example, the timer described in Condition 6) expires.

### Content of Report

The performance report may include information indicating the one or more pieces of monitored performance described in the first embodiment. The number of pieces of information indicating the monitored performance included in the performance report may be determined based on K (/K′) described in the second embodiment.

The performance report may include information indicating model/non-AI-based CSI feedback corresponding to performance to be reported (for example, a model ID, a registered model ID, or a CSI report configuration ID).

The UE may determine the performance to be reported, based on at least one of the following:
performance evaluated in the condition described in the second embodiment (for example, at least one of Conditions 1 to 6),
performance selected based on K (/K′) described in the second embodiment, and
performance determined as a reporting target, based on notification from the NW.

The notification may be, for example, an activation command for a model/non-AI-based CSI feedback, or may be notification including information indicating a reporting/monitoring target. The UE may report performance of a model to be activated/monitored.

For example, in a case where the UE includes models #1 and #2 and where only model #2 of these models is activated, the UE may report performance of model #2. The UE may not report performance of model #1.

According to the third embodiment described above, the UE can appropriately transmit a performance report.

### Fourth Embodiment

A fourth embodiment relates to a model request.

### Transmission Timing of Model Request

A transmission timing of a model request may be determined based on the description obtained by interpreting the performance report as the model request in the description of the timing of the performance report in the third embodiment.

### Content of Model Request

The model request may include information indicating a model/non-AI-based CSI feedback to be applied (for example, a model ID, a registered model ID, or a CSI report configuration ID).

The model/non-AI-based CSI feedback to be applied may correspond to a model/non-AI-based CSI feedback corresponding to the performance to be reported described in the third embodiment (note that the performance may not be reported). The model/non-AI-based CSI feedback to be applied may be referred to as a recommended model/non-AI-based CSI feedback.

For example, assume a case where a UE includes models #1 and #2, type II and enhanced type II are available as non-AI-based CSI feedbacks, and only model #2 of these models is activated. The UE may evaluate performance (for example, CQIs) of these models/non-AI-based CSI feedbacks, and may select the evaluated non-AI-based CSI feedback as the recommended model/non-AI-based CSI feedback. The UE may report, to the NW, a model request indicating the non-AI-based CSI feedback.

Note that the UE may transmit the information included in the performance report and the information included in the model request simultaneously (for example, by using one piece of UCI/MAC CE).

According to the fourth embodiment described above, the UE can appropriately transmit a model request.

### Fifth Embodiment

A fifth embodiment relates to model activation/deactivation.

The UE may perform model activation/deactivation, based on information notified from a NW. The information may be referred to as a model activation/deactivation command, and may be transmitted by using RRC/MAC CE/DCI.

The model activation/deactivation command may include information indicating a model/non-AI-based CSI feedback to be activated/deactivated (for example, a model ID, a registered model ID, or a CSI report configuration ID).

The model activation/deactivation command may correspond to information indicating whether the model request described in the fourth embodiment has been accepted (which may be referred to as, for example, a model response). In response to reception of a corresponding model response after transmission of a model request, the UE may activate a model indicated by the model request when the model response indicates that the model request has been accepted, otherwise the UE may deactivate the model.

The UE itself may determine a model/non-AI-based CSI feedback to be activated/deactivated. For example, when the condition described in the second embodiment (for example, at least one of Conditions 1 to 6) is satisfied, the UE may determine the model/non-AI-based CSI feedback to be activated/deactivated. The model/non-AI-based CSI feedback to be activated/deactivated may correspond to a model/non-AI-based CSI feedback corresponding to the performance to be reported described in the third embodiment (note that the performance may not be reported).

The UE may report, to the NW, information related to a model to be activated or information indicating that an active model is changed. In this case, a model request/performance report becomes unnecessary, and thus reduction in communication overhead can be expected.

Note that the UE may expect only one or a plurality of models/non-AI-based CSI feedbacks for a certain function to be active.

When a certain model is activated (active), the UE may apply the model to calculation of CSI feedback information. When the certain model is activated, the UE may not perform CSI calculation/CSI reporting based on configured non-AI-based CSI feedback that is not for performance monitoring.

When all the models are inactive, the UE may apply a non-AI-based CSI feedback scheme to the calculation of the CSI feedback information. The UE may be configured with information related to the non-AI-based CSI feedback scheme applied when all the models are inactive (for example, by using an CSI report configuration information element of RRC).

When all the models are inactive, the UE may not perform CSI feedback.

### Model Application Time (Active/Inactive Time)

The UE may activate/deactivate a certain model during a model application time.

The model application time may correspond to a period from start time (start point) until end time (end point).

The start time may correspond to at least one of the following:
A last symbol for receiving a model activation/deactivation command, or time after X unit time from the last symbol, and
A last symbol for transmitting HARQ information (for example, HARQ-ACK) corresponding to a model activation/deactivation command, or time after X unit time from the last symbol.

In the present disclosure, the unit time may be interpreted as at least one of symbol(s), slot(s), subslot(s), subframe(s), second(s) (millisecond(s)), and the like.

The end time may correspond to at least one of the following:
time after Y unit time from corresponding start time,
time after Y unit time from application/reception of a corresponding model activation/deactivation command, and
time until application/reception of a new model activation/deactivation command.

Values of X, Y, and the like (or information related to the values) may be predefined in a specification, may be determined based on a UE capability, may be notified to the UE from the NW, or may be information associated with a model (may be determined based on a model). The model activation/deactivation command may include information related to the model application time (for example, information indicating X/Y).

Note that, when receiving the new model activation/deactivation command during the model application time, the UE may restart the start time for the model application time (which may be updated to the above-described start time based on the new model activation/deactivation command). The case that the start time for the model application time is restarted may be at least one case of the following:
a case where model information specified by the above-described new model activation/deactivation command is the same as a currently applied model, and
a case where the above-described new model activation/deactivation command does not include information related to model information/application time.

Note that the UE may apply different methods for determining (or updating) the start time/end time in respective ones of a case of activation and a case of deactivation.

The UE apply different methods for determining (or updating) the start time/end time in respective ones of a case of model activation/deactivation and a case of fallback scheme activation/deactivation.

According to the fifth embodiment described above, the UE can appropriately control model activation/deactivation.

### Variations of Fifth Embodiment (Determination of an AI Model to be Monitored)

The UE may determine the AI model to be monitored, based on the description obtained by interpreting “activate” (activation)/“deactivate” (deactivation) as “activate/deactivate monitoring” (monitoring activation/deactivation) in the description of the model activation/deactivation in the fifth embodiment.

Only when at least one of the following is satisfied for a configured AI model, the UE may monitor the AI model:
reception of activation of the model,
determination of activation of the model,
during a model application period for the model,
until performance of the model is determined (in other words, the performance has not yet been determined),
until performance of the model is reported (in other words, the performance has not yet been reported), and
during a certain period from reception of an activation command for monitoring of the model (triggering signal for the monitoring).

The certain period may correspond to the period obtained by interpreting the above-described model application period as a model application period for the model. In other words, the model activation/deactivation and the model monitoring activation/deactivation may be controlled separately or simultaneously.

According to the variations of the fifth embodiment described above, the UE can appropriately control monitoring of a model.

### Sixth Embodiment

A sixth embodiment relates to reporting for performance monitoring from a UE and performance monitoring in a BS.

### Reporting for Performance Monitoring

For performance monitoring for a certain model (encoder, decoder) in the BS, the UE may report the following:
CSI feedback information (encoded bit) generated by the model, and
CSI with non-AI-based CSI feedback corresponding to the above-described AI-based CSI feedback.

Here, the non-AI-based CSI feedback may be a non-AI-based PMI (PMI also defined in an existing specification). In the sixth embodiment, this reported PMI is hereinafter simply described as a PMI. Note that this PMI may be a PMI computed in consideration of post-processing (for example, DFT) of an AI model.

The CSI feedback information may be information obtained by encoding, by using an AI model, CSI (for example, a channel matrix, a precoding matrix, a precoding vector, or an eigenvector) computed by channel measurement and used for computation of a PMI. In this case, there is no need to apply different processings for the performance monitoring.

The CSI feedback information may be information obtained by encoding, by using an AI model, CSI (for example, a channel matrix, a precoding matrix, a precoding vector, or an eigenvector) reconstructed based on a PMI. In this case, the performance monitoring can simply monitor the performance of the AI model without consideration of effect of quantization error caused by the PMI.

The UE may determine the above-described PMI, based on notification from the NW. For example, the UE may determine that a PMI configured (reported) in a trigger state (CSI trigger state) for AI-based CSI feedback is the above-described PMI.

The UE may be configured to report CSI including CSI feedback information based on AI-based CSI feedback, and a corresponding PMI. The UE may be notified of a CSI-RS resource/CSI-RS resource set/CSI resource configuration/CSI report configuration for (reporting for) performance monitoring.

Note that the PMI (non-AI-based PMI) may correspond to a PMI generated by using a codebook without an AI model (for example, type I CSI feedback, type II CSI feedback, enhanced type II CSI feedback, further enhanced type II port selection CSI feedback, and the like).

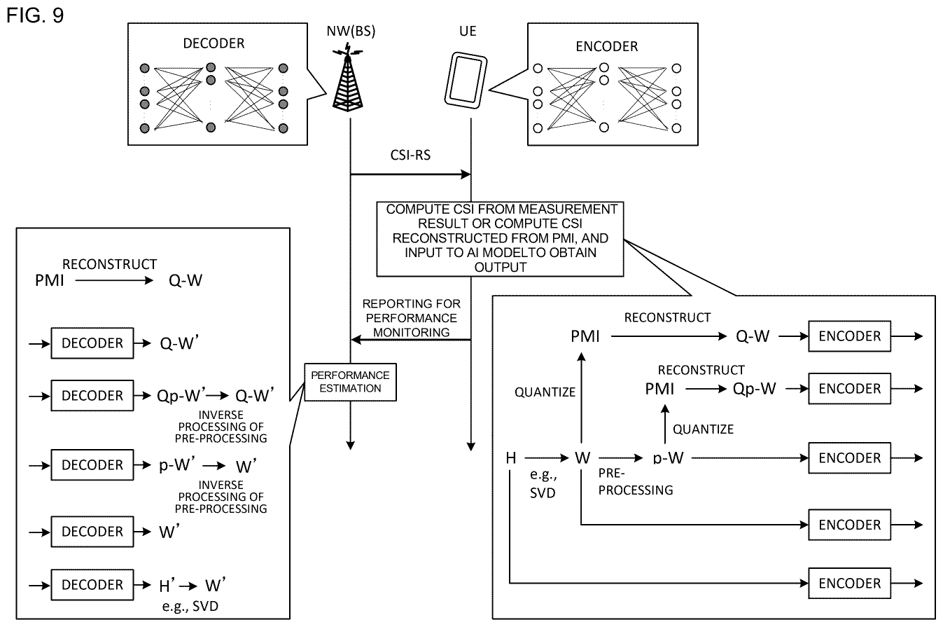

FIG. 9 is a diagram to show an example of the performance monitoring in the sixth embodiment. In the present example, for simplicity, assume that CSI output from the decoder is reconstructed CSI corresponding to an input to an encoder. The UE includes at least one illustrated encoder, and the BS includes at least one illustrated decoder corresponding to the encoder included by the UE.

In the present example, the UE may perform channel measurement, based on an CSI-RS transmitted from the BS, and may compute CSI (for example, a channel matrix H, a precoding matrix W, a pre-processed precoding matrix p-W). The UE may reconstruct the PMI obtained by quantizing W (or p-W) to compute the reconstructed precoding matrix Q-W (or the reconstructed pre-processed precoding matrix Q-W).

The UE may transmit a performance monitoring report including, as CSI feedback information, the output obtained by inputting these pieces of CSI/reconstructed CSI to the encoder. The UE may transmit the performance monitoring report including the illustrated PMI.

The BS may perform performance monitoring (performance estimation, performance comparison), based on the received performance monitoring report. The illustrated decoders each corresponds to an encoder on the UE side (for example, the lowest decoder is a decoder for inputting CSI feedback information to output H′ obtained by reconstructing H). Note that, in the present example, “′” represents an output of a decoder corresponding to CSI on the encoder side (reconstructed CSI).

The BS inputs the CSI feedback information included in the performance monitoring report to a corresponding decoder to output reconstructed CSI. In the present example, the BS derives W′ or Q-W′ by applying SVD, inverse processing of pre-processing, or the like as necessary.

The BS reconstructs the PMI included in the performance monitoring report (here, the PMI obtained by quantizing W) and computes the CSI (Q-W) reconstructed based on the PMI.

The BS may determine a model with higher performance by comparing obtained W′ or Q-W′ with Q-W.

The UE may be configured to report CSI including CSI feedback information based on AI-based CSI feedback, and a corresponding PMI, for semi-persistent CSI reporting, depending on one CSI trigger state. In this case, one piece of DCI can activate CSI reporting required for performance monitoring at the BS.

Note that, in an existing NR specification, one trigger state of semi-persistent CSI transmitted by using a PUSCH (corresponding to an RRC information element “CSI-SemiPersistentOnPUSCH-TriggerState”) is associated with only one CSI report configuration ID (CSI-ReportConfigId). On the other hand, in the sixth embodiment, one trigger state of the semi-persistent CSI transmitted by using the PUSCH may be associated with a plurality of CSI report configuration IDs (CSI-ReportConfigId). The one trigger state may be associated with non-AI-based CSI report information and AI-based CSI report information for performance monitoring.

For example, assume a case where the UE includes models #1 and #2 and where enhanced type II is available as a non-AI-based CSI feedback. The UE may transmit, to the BS, a performance monitoring report including outputs of models #1 and #2 and the non-AI-based CSI feedback (for example, a PMI).

### Granularity of Non-AI-Based CSI Feedback for Performance Monitoring Report

The UE may use granularity different from that defined in an existing specification (for example, finer, greater, or enhanced granularity) as granularity of non-AI-based CSI feedback for a performance monitoring report.

The UE may use the granularity different from that of the existing specification for at least one parameter of the following:
a parameter related to a broadband/subband phase coefficient (for example, phaseAlphabetSize),
a parameter related to a broadband/subband amplitude coefficient,
a parameter related to the number of coefficients/non-zero coefficients (for example, codebook parameter configuration for L, β, p_v, and the like, or the like),
a parameter related to the number of beams (for example, numberOfBeams), and
a parameter associated with a CSI feedback subband (for example, numberOfPMI-SubbandsPerCQI-Subband, subBandSize).

The UE may apply the above-described different granularity only when some AI models for CSI feedback are registered/configured for the UE.

According to the sixth embodiment described above, the BS can appropriately perform performance monitoring.

### SUPPLEMENT

### AI Model Information

In the present disclosure, AI model information may refer to information including at least one of the following:
information of an input/output of an AI model,
information of pre-processing/post-processing for an input/output of an AI model,
information of parameters of an AI model,
training information for an AI model,
inference information for an AI model, and
performance information related to an AI model.

Here, the information of an input/output of AI model may refer to information including at least one of the following:
Contents of input/output data (for example, RSRP, SINR, amplitude/phase information in a channel matrix (or precoding matrix), information related to an angle of arrival (AoA), information related to an angle of departure (AoD), location information),
auxiliary information of data (which may be referred to as meta information),
a type of input/output data (for example, an immutable value, a floating-point value),
a bit width of input/output data (for example, 64 bits for each input value),
a quantization interval of input/output data (a quantization step size) (for example, 1 dBm for L1-RSRP), and
a possible range of input/output data (for example, [0, 1]).

Note that in the present disclosure, the information related to the AoA may include information related to at least one of an azimuth angle of arrival and a zenith angle of arrival (ZoA). The information related to the AoD may include information related to at least one of, for example, an azimuth angle of departure and a zenith angle of departure (ZoD).

In the present disclosure, the location information may be location information related to the UE/NW. The location information may include at least one of information (for example, a latitude, a longitude, or an altitude) obtained by using a positioning system (for example, satellite positioning system (such as Global Navigation Satellite System (GNSS) and Global Positioning System (GPS)), information of a BS adjacent to the UE (or a serving BS) (for example, an identifier (ID) of the BS/cell, a distance between the BS and the UE, a direction/angle of the BS (UE) when viewed from the UE (BS), coordinates of the BS (UE) when viewed from the UE (BS) (for example, the X/Y/Z-axis coordinates) or the like), a specific address (for example, an Internet Protocol (IP) address) of the UE, and the like. The location information of the UE is not limited to information with reference to the position of the BS and may be information with reference to a specific point.

The location information may include information related to the implementation of the UE itself (for example, the location (position)/direction of an antenna, the location/direction of an antenna panel, the number of antennas, the number of antenna panels, or the like).

The location information may include mobility information. The mobility information may include information indicating at least one of information indicating a mobility type, a moving speed of the UE, an acceleration of the UE, a moving direction of the UE, and the like.

Here, the mobility type may correspond to at least one of fixed location UE, movable/moving UE, no mobility UE, low mobility UE, middle mobility UE, high mobility UE, cell-edge UE, not-cell-edge UE, and the like.

In the present disclosure, environment information (for data) may be information related to an environment in which the data is acquired/used, and may correspond to, for example, frequency information (such as a band ID), environment type information (information indicating at least one of indoor, outdoor, Urban Macro (UMa), Urban Micro (Umi), and the like), information indicating Line Of Site (LOS)/Non-Line Of Site (NLOS), and the like.

Here, LOS may mean that the UE and the BS are in an environment where they can see each other (or there is no shield), and NLOS may mean that the UE and the BS are not in an environment where they can see each other (or there is a shield). The information indicating LOS/NLOS may indicate a soft value (for example, probability of LOS/NLOS) or a hard value (for example, either of LOS/NLOS).

In the present disclosure, the meta information may mean, for example, information related to input/output information suitable for an AI model, information related to acquired/available data, or the like. Specifically, the meta information may include information related to a beam of an RS (for example, a CSI-RS/SRS/SSB or the like) (for example, an angle of a direction of each beam, a 3 dB beam width, a shape of a directed beam, the number of beams), gNB/UE antenna layout information, frequency information, environment information, a meta information ID, and the like. Note that the meta information may be used as an input/output of an AI model.

The information of pre-processing/post-processing for an input/output of an AI model described above may include information related to at least one of the following:
whether to apply normalization (for example, Z score normalization (standardization), minimum-maximum (min-max) normalization),
parameters for normalization (for example, a mean/variance for Z score normalization, a minimum/maximum value for min-max normalization),
whether to apply a specific numerical inversion method (for example, one hot encoding, label encoding, and the like), and
a selection rule whether to be used as training data.

For example, the Z score normalization as the pre-processing may be performed on input information x to obtain normalized input information x_{new} (x_{new}=(x−μ)/σ, where μ represents a mean of x, σ represents a standard deviation) and the obtained normalized input information x_{new} may be input to an AI model, and the post-processing may be performed on an output yₒᵤₜ from the AI model to obtain a final output y.

The information of parameters of an AI model described above may include information related to at least one of the following:
weight (for example, a coefficient (coupling coefficient) of a neuron) information in an AI model,
a structure of an AI model,
a type of an AI model as a model component (for example, Residual Network (ResNet), DenseNet, RefineNet, a transformer model, CRBlock, a recurrent neural network (RNN), a long short-term memory (LSTM), a gated recurrent unit (GRU)), and
a function of an AI model as a model component (for example, decoder, encoder).

Note that the weight information in an AI model may include information related to at least one of the following:
a bit width (size) of the weight information,
a quantization interval of the weight information,
granularity of the weight information,
a possible range of the weight information,
parameters of a weight in an AI model,
information of a difference from a pre-updated AI model (in a case of updating) and,
a weight initialization method (for example, zero-initialization, random initialization (based on normal distribution/uniform distribution/truncated normal distribution), Xavier initialization (for sigmoid function), He initialization (for rectified linear units (ReLU)).

The structure of an AI model described above may include information related to at least one of the following:
the number of layers,
a type of a layer (for example, a convolutional layer, an activation layer, a dense layer, a normalization layer, a pooling layer, an attention layer),
layer information,
time series-specific parameters (for example, bidirectionality, time step), and
parameters of training (for example, a type of a function (L2 regularization, dropout function, and the like), where to arrange this function (for example, after which layer)).

The layer information may include information related to at least one of the following:
the number of neurons in each layer.
a kernel size,
a stride for pooling layer/convolutional layer,
a pooling method (MaxPooling, AveragePooling, and the like),
information of a residual block,
the number of heads,
a normalization method (batch normalization, instance normalization, layer normalization, and the like), and
an activation function (sigmoid, tanh function, ReLU, leaky ReLU information, Maxout, Softmax).

A certain AI model may be included as a component of another AI model. For example, the certain AI model may be an AI model in which processing proceeds from a ResNet that is model component #1 to a transformer model that is model component #2 to a dense layer to a normalization layer.

Training information for the above AI model may include information related to at least one of the following:
information for an optimization algorithm (for example, a kind of optimization (stochastic gradient descent (SGD)), AdaGrad, Adam, and the like), parameters for optimization (learning rate, momentum information, and the like),
information of a loss function (for example, information related to a loss function indexes (metrics) (mean absolute error (MAE)), mean square error (MSE), a cross-entropy loss, NLLLoss, Kullback-Leibler (KL) divergence, and the like),
parameters to be frozen for training (for example, a layer, a weight),
parameters to be updated (for example, a layer, a weight),
parameters to be initial parameters (to be used as initial parameters) for training (for example, a layer, a weight), and
a method of training/updating an AI model (for example, the (recommended) number of epochs, a batch size, the number of pieces of data used for training).

The inference information for an AI model described above may include information related to decision tree branch pruning, parameter quantization, an AI model function, and the like. Here, the AI model function may correspond to, for example, at least one of time-domain beam prediction, spatial-domain beam prediction, an autoencoder for CSI feedback, an autoencoder for beam management, and the like.

The autoencoder for CSI feedback may be used as follows:
the UE transmits, as CSI feedback (CSI report), an encoded bit output by inputting CSI/channel matrix/precoding matrix to an AI model of an encoder, and
the BS reconstructs the CSI/channel matrix/precoding matrix output by inputting the received encoded bit to an AI model of a decoder.

In spatial-domain beam prediction, the UE/BS may input, to the AI model, a measurement result (beam quality, for example, RSRP) based on a sparse (or thick) beam to output dense (or thin) beam quality.

In time-domain beam prediction, the UE/BS may input, to the AI model, a time-series (past, current, or the like) measurement result (beam quality, for example, RSRP) to output future beam quality.

The performance information related to an AI model described above may include information related to an expected value of a loss function defined for the AI model.

The AI model information in the present disclosure may include information related to a range of application (applicable range) of an AI model. The range of the application may be indicated by a physical cell ID, a serving cell index, or the like. The above-described environment information may include information related to the range of the application.

The AI model information related to a specific AI model may be predefined in a standard, or the UE may be notified of the AI model information from a network (NW). The AI model defined in a standard may be referred to as a reference AI model. The AI model information related to the reference AI model may be referred to as reference AI model information.

Note that the AI model information in the present disclosure may include an index for specifying an AI model (which may be referred to as an AI model index, an AI model ID, a model ID, and the like, for example). The AI model information in the present disclosure may include the AI model index in addition to/instead of the information of an input/output of an AI model described above. Association of the AI model index with the AI model information (for example, the information of an input/output of an AI model) may be predefined in a standard, or the UE may be notified of the association from the NW.

The AI model information in the present disclosure may be associated with an AI model, and may be referred to as AI model relevant information, relevant information simply, and so on. The AI model relevant information may not explicitly include information for specifying an AI model. The AI model relevant information may be, for example, information including only meta information.

In the present disclosure, a model ID and an ID corresponding to an AI model set (model set ID) may be interchangeably interpreted. In the present disclosure, a model ID and a meta information ID may be interchangeably interpreted. As described above, meta information (or meta information ID) may be associated with information related to a beam (beam configuration). For example, the meta information (or meta information ID) may be used by the UE to select an AI model in consideration of which beam is used by the BS, or may be used to notify which beam is to be used by the BS to apply an AI model deployed by the UE. Note that, in the present disclosure, the meta information ID and an ID corresponding to a meta information set (meta information set ID) may be interchangeably interpreted.

### Notification of Information to UE

Any notification of information (from a NW) to a UE (in other words, any reception, in a UE, of information from a BS) in the above-described embodiments may be performed by using physical layer signaling (for example, DCI), higher layer signaling (for example, RRC signaling, a MAC CE), a specific signal/channel (for example, a PDCCH, a PDSCH, a reference signal), or combinations of these.

In a case where the notification described above is performed by the MAC CE, the MAC CE may be identified by a new logical channel ID (LCID) being included in a MAC sub-header, the new logical channel ID being not defined in an existing specification.

In a case where the notification described above is performed by the DCI, the notification described above may be performed by use of a specific field of the DCI, a radio network temporary identifier (RNTI) used to scramble a cyclic redundancy check (CRC) bit attached to the DCI, a format of the DCI, and the like.

Any notification of information to a UE in the above-described embodiments may be performed periodically, semi-persistently, or aperiodically.

### Notification of Information From UE

Any notification of information from a UE (to a NW) (in other words, any transmission, in a UE, of information to a BS) in the above-described embodiments may be performed by using physical layer signaling (for example, UCI), higher layer signaling (for example, RRC signaling, a MAC CE), a specific signal/channel (for example, a PUCCH, a PUSCH, a reference signal), or combinations of these.

In a case where the notification described above is performed by the MAC CE, the MAC CE may be identified by a new LCID being included in a MAC sub-header, the new LCID being not defined in an existing specification.

In a case where the notification described above is performed by the UCI, the notification described above may be transmitted by using a PUCCH or a PUSCH.

Any notification of information from a UE in the above-described embodiments may be performed periodically, semi-persistently, or aperiodically.

### Application of Respective Embodiments

At least one of the above-described embodiments may be applied to a case where a specific condition is satisfied. The specific condition may be defined in a specification, or may be notified to the UE/BS by using higher layer signaling/physical layer signaling.

At least one of the above-described embodiments may be applied only to a UE that has reported specific UE capabilities or that supports the specific UE capabilities.

The specific UE capabilities may indicate at least one of the following:
supporting specific processing/operation/control/information for at least one of the above-described embodiments,
the number of monitored AI models (which may be a value for each function),
maximum floating point operations (FLOPs (note that “s” is a lowercase letter)) of the AI model capable of being deployed by the UE (this means an amount of the maximum floating point operations),
the maximum number of parameters for the AI model the UE can deploy,
a layer/algorithm/function the UE supports,
computation capability, and
data collection capability.

The specific UE capability may be capability applied over all the frequencies (commonly irrespective of frequency), capability per frequency (for example, one or combinations of a cell, a band, a band combination, a BWP, a component carrier, and the like), capability per frequency range (for example, Frequency Range 1 (FR1), FR2, FR3, FR4, FR5, FR2-1, FR2-2), capability per subcarrier spacing (SCS), or capability per Feature Set (FS) or Feature Set Per Component-carrier (FSPC).

The specific UE capabilities described above may be a capability applied across all duplex modes (commonly regardless of duplex mode), or a capability per duplex mode (for example, time division duplex (TDD), frequency division duplex (FDD)).

At least one of the above-described embodiments may be applied to a case where specific information associated with the above-described embodiments (or operation for the above-described embodiments) is configured/activated/triggered for the UE by higher layer signaling/physical layer signaling. For example, the specific information may be information indicating enabling of a use of an AI model, any RRC parameter for a specific release (for example, Rel. 18), or the like.

In a case where the UE does not support at least one of the specific UE capabilities described above or is not configured with the specific information, the UE may apply, for example, Rel-15/16 operation.

Note that at least one of the above-described embodiments may be used for (compression of) UE-BS information transmission except for the CSI. For example, the UE may (generate by using the encoder, for example, and) report information related to a location (or positioning)/information related to location estimation in the location management function (LMF) to the network in accordance with at least one of the above-described embodiments. The information may be information of a channel impulse response (CIR) per subband/per antenna port. Reporting this information allows the BS to estimate the location of the UE without reporting an angle/time difference of a received signal.

### SUPPLEMENTARY NOTES

The following invention is supplemented for one embodiment of the present disclosure.

### Supplementary Note 1

A terminal including:
a receiving section that receives, for artificial intelligence (AI)-based channel state information (CSI) feedback, configuration information for performance monitoring; and
a control section that controls the performance monitoring.

### Supplementary Note 2

The terminal according to supplementary note 1, wherein the control section monitors performance of CSI computed based on an output of an AI model, the CSI being compared with target CSI.

### Supplementary Note 3

The terminal according to supplementary note 1 or 2, wherein the control section monitors expected performance of an AI model.

### Supplementary Note 4

The terminal according to any one of supplementary notes 1 to 3, wherein the control section monitors performance of non-AI-based CSI feedback.

### SUPPLEMENTARY NOTES

The following invention is supplemented for one embodiment of the present disclosure.

### Supplementary Note 1

A terminal including:
a receiving section that receives, for artificial intelligence (AI)-based channel state information (CSI) feedback, configuration information for reporting for performance monitoring; and
a control section that controls transmission of a report related to CSI measured based on the configuration information.

### Supplementary Note 2

The terminal according to supplementary note 1, wherein the control section includes, in the report, an output obtained by inputting the CSI to an AI model.

### Supplementary Note 3

The terminal according to supplementary note 1 or 2, wherein the control section includes, in the report, a precoding matrix indicator (PMI) obtained based on the CSI.

### Supplementary Note 4

The terminal according to any one of supplementary notes 1 to 3, wherein the control section includes, in the report, CSI reconstructed based on a precoding matrix indicator (PMI) obtained based on the CSI.

### Radio Communication System

Hereinafter, a structure of a radio communication system according to one embodiment of the present disclosure will be described. In this radio communication system, the radio communication method according to each embodiment of the present disclosure described above may be used alone or may be used in combination for communication.

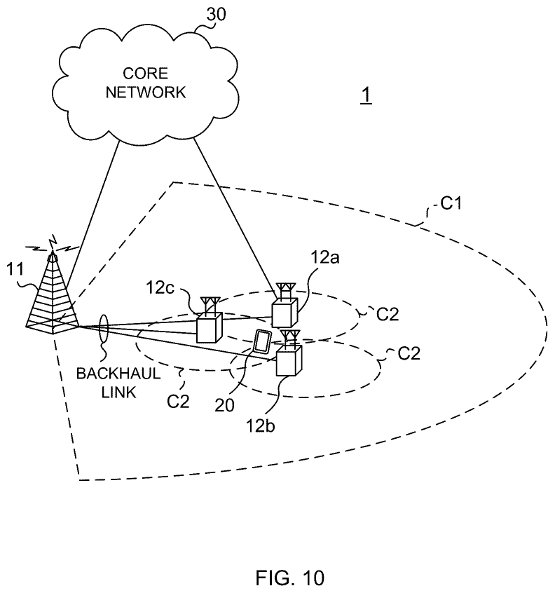

FIG. 10 is a diagram to show an example of a schematic structure of the radio communication system according to one embodiment. The radio communication system 1 (which may be simply referred to as a system 1) may be a system implementing a communication using Long Term Evolution (LTE), 5th generation mobile communication system New Radio (5G NR) and so on the specifications of which have been drafted by Third Generation Partnership Project (3GPP).

The radio communication system 1 may support dual connectivity (multi-RAT dual connectivity (MR-DC)) between a plurality of Radio Access Technologies (RATs). The MR-DC may include dual connectivity (E-UTRA-NR Dual Connectivity (EN-DC)) between LTE (Evolved Universal Terrestrial Radio Access (E-UTRA)) and NR, dual connectivity (NR-E-UTRA Dual Connectivity (NE-DC)) between NR and LTE, and so on.

In EN-DC, a base station (eNB) of LTE (E-UTRA) is a master node (MN), and a base station (gNB) of NR is a secondary node (SN). In NE-DC, a base station (gNB) of NR is an MN, and a base station (eNB) of LTE (E-UTRA) is an SN.

The radio communication system 1 may support dual connectivity between a plurality of base stations in the same RAT (for example, dual connectivity (NR-NR Dual Connectivity (NN-DC)) where both of an MN and an SN are base stations (gNB) of NR).

The radio communication system 1 may include a base station 11 that forms a macro cell C1 of a relatively wide coverage, and base stations 12 (12a to 12c) that form small cells C2, which are placed within the macro cell C1 and which are narrower than the macro cell C1. The user terminal 20 may be located in at least one cell. The arrangement, the number, and the like of each cell and user terminal 20 are by no means limited to the aspect shown in the diagram. Hereinafter, the base stations 11 and 12 will be collectively referred to as “base stations 10,” unless specified otherwise.

The user terminal 20 may be connected to at least one of the plurality of base stations 10. The user terminal 20 may use at least one of carrier aggregation (CA) and dual connectivity (DC) using a plurality of component carriers (CCs).

Each CC may be included in at least one of a first frequency band (Frequency Range 1 (FR1)) and a second frequency band (Frequency Range 2 (FR2)). The macro cell C1 may be included in FR1, and the small cells C2 may be included in FR2. For example, FR1 may be a frequency band of 6 GHz or less (sub-6 GHz), and FR2 may be a frequency band which is higher than 24 GHz (above-24 GHz). Note that frequency bands, definitions and so on of FR1 and FR2 are by no means limited to these, and for example, FR1 may correspond to a frequency band which is higher than FR2.

The user terminal 20 may communicate using at least one of time division duplex (TDD) and frequency division duplex (FDD) in each CC.

The plurality of base stations 10 may be connected by a wired connection (for example, optical fiber in compliance with the Common Public Radio Interface (CPRI), the X2 interface and so on) or a wireless connection (for example, an NR communication). For example, if an NR communication is used as a backhaul between the base stations 11 and 12, the base station 11 corresponding to a higher station may be referred to as an “Integrated Access Backhaul (IAB) donor,” and the base station 12 corresponding to a relay station (relay) may be referred to as an “IAB node.”

The base station 10 may be connected to a core network 30 through another base station 10 or directly. For example, the core network 30 may include at least one of Evolved Packet Core (EPC), 5G Core Network (5GCN), Next Generation Core (NGC), and so on.

The core network 30 may include network functions (NF) such as a User Plane Function (UPF), an Access and Mobility management Function (AMF), a Session Management Function (SMF), Unified Data Management (UDM), an ApplicationFunction (AF), a Data Network (DN), a Location Management Function (LMF), and operation, administration, and maintenance (Management) (OAM). Note that a plurality of functions may be provided by one network node. Communication with an external network (for example, the Internet) may be performed via the DN.

The user terminal 20 may be a terminal supporting at least one of communication schemes such as LTE, LTE-A, 5G, and so on.

In the radio communication system 1, an orthogonal frequency division multiplexing (OFDM)-based wireless access scheme may be used. For example, in at least one of the downlink (DL) and the uplink (UL), Cyclic Prefix OFDM (CP-OFDM), Discrete Fourier Transform Spread OFDM (DFT-s-OFDM), Orthogonal Frequency Division Multiple Access (OFDMA), Single Carrier Frequency Division Multiple Access (SC-FDMA), and so on may be used.

The wireless access scheme may be referred to as a “waveform.” Note that, in the radio communication system 1, another wireless access scheme (for example, another single carrier transmission scheme, another multi-carrier transmission scheme) may be used for a wireless access scheme in the UL and the DL.

In the radio communication system 1, a downlink shared channel (Physical Downlink Shared Channel (PDSCH)), which is used by each user terminal 20 on a shared basis, a broadcast channel (Physical Broadcast Channel (PBCH)), a downlink control channel (Physical Downlink Control Channel (PDCCH)) and so on, may be used as downlink channels.

In the radio communication system 1, an uplink shared channel (Physical Uplink Shared Channel (PUSCH)), which is used by each user terminal 20 on a shared basis, an uplink control channel (Physical Uplink Control Channel (PUCCH)), a random access channel (Physical Random Access Channel (PRACH)) and so on may be used as uplink channels.

User data, higher layer control information, System Information Blocks (SIBs) and so on are communicated on the PDSCH. User data, higher layer control information and so on may be communicated on the PUSCH. The Master Information Blocks (MIBs) may be communicated on the PBCH.

Lower layer control information may be communicated on the PDCCH. For example, the lower layer control information may include downlink control information (DCI) including scheduling information of at least one of the PDSCH and the PUSCH.

Note that DCI for scheduling the PDSCH may be referred to as “DL assignment,” “DL DCI,” and so on, and DCI for scheduling the PUSCH may be referred to as “UL grant,” “UL DCI,” and so on. Note that the PDSCH may be interpreted as “DL data,” and the PUSCH may be interpreted as “UL data.”

For detection of the PDCCH, a control resource set (CORESET) and a search space may be used. The CORESET corresponds to a resource to search DCI. The search space corresponds to a search area and a search method of PDCCH candidates. One CORESET may be associated with one or more search spaces. The UE may monitor a CORESET associated with a certain search space, based on search space configuration.

One search space may correspond to a PDCCH candidate corresponding to one or more aggregation levels. One or more search spaces may be referred to as a “search space set.” Note that a “search space,” a “search space set,” a “search space configuration,” a “search space set configuration,” a “CORESET,” a “CORESET configuration” and so on of the present disclosure may be interchangeably interpreted.

Uplink control information (UCI) including at least one of channel state information (CSI), transmission confirmation information (for example, which may be referred to as Hybrid Automatic Repeat reQuest ACKnowledgement (HARQ-ACK), ACK/NACK, and so on), and scheduling request (SR) may be communicated by means of the PUCCH. By means of the PRACH, random access preambles for establishing connections with cells may be communicated.

Note that the downlink, the uplink, and so on in the present disclosure may be expressed without a term of “link.” In addition, various channels may be expressed without adding “Physical” to the head.

In the radio communication system 1, a synchronization signal (SS), a downlink reference signal (DL-RS), and so on may be communicated. In the radio communication system 1, a cell-specific reference signal (CRS), a channel state information-reference signal (CSI-RS), a demodulation reference signal (DMRS), a positioning reference signal (PRS), a phase tracking reference signal (PTRS), and so on may be communicated as the DL-RS.

For example, the synchronization signal may be at least one of a primary synchronization signal (PSS) and a secondary synchronization signal (SSS). A signal block including an SS (PSS, SSS) and a PBCH (and a DMRS for a PBCH) may be referred to as an “SS/PBCH block,” an “SS Block (SSB),” and so on. Note that an SS, an SSB, and so on may be also referred to as a “reference signal.”

In the radio communication system 1, a reference signal for measurement (Sounding Reference Signal (SRS)), a demodulation reference signal (DMRS), and so on may be communicated as an uplink reference signal (UL-RS). Note that DMRS may be referred to as a “user terminal specific reference signal (UE-specific Reference Signal).”

### Base Station

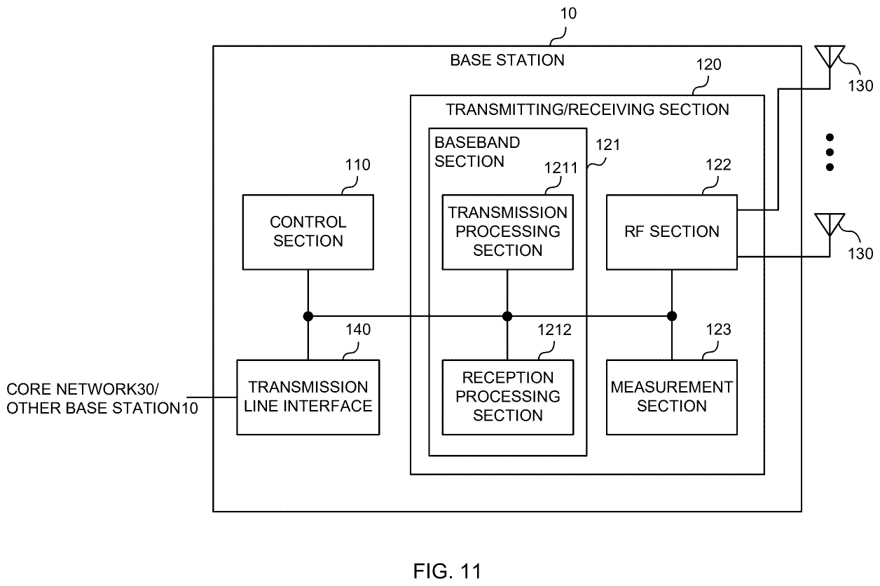

FIG. 11 is a diagram to show an example of a structure of the base station according to one embodiment. The base station 10 includes a control section 110, a transmitting/receiving section 120, transmitting/receiving antennas 130 and a transmission line interface 140. Note that the base station 10 may include one or more control sections 110, one or more transmitting/receiving sections 120, one or more transmitting/receiving antennas 130, and one or more transmission line interfaces 140.

Note that, the present example primarily shows functional blocks that pertain to characteristic parts of the present embodiment, and it is assumed that the base station 10 may include other functional blocks that are necessary for radio communication as well. Part of the processes of each section described below may be omitted.

The control section 110 controls the whole of the base station 10. The control section 110 can be constituted with a controller, a control circuit, or the like described based on general understanding of the technical field to which the present disclosure pertains.

The control section 110 may control generation of signals, scheduling (for example, resource allocation, mapping), and so on. The control section 110 may control transmission and reception, measurement and so on using the transmitting/receiving section 120, the transmitting/receiving antennas 130, and the transmission line interface 140. The control section 110 may generate data, control information, a sequence and so on to transmit as a signal, and forward the generated items to the transmitting/receiving section 120. The control section 110 may perform call processing (setting up, releasing) for communication channels, manage the state of the base station 10, and manage the radio resources.

The transmitting/receiving section 120 may include a baseband section 121, a Radio Frequency (RF) section 122, and a measurement section 123. The baseband section 121 may include a transmission processing section 1211 and a reception processing section 1212. The transmitting/receiving section 120 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 120 may be structured as a transmitting/receiving section in one entity, or may be constituted with a transmitting section and a receiving section. The transmitting section may be constituted with the transmission processing section 1211, and the RF section 122. The receiving section may be constituted with the reception processing section 1212, the RF section 122, and the measurement section 123.

The transmitting/receiving antennas 130 can be constituted with antennas, for example, an array antenna, or the like described based on general understanding of the technical field to which the present disclosure pertains.

The transmitting/receiving section 120 may transmit the above-described downlink channel, synchronization signal, downlink reference signal, and so on. The transmitting/receiving section 120 may receive the above-described uplink channel, uplink reference signal, and so on.

The transmitting/receiving section 120 may form at least one of a transmit beam and a receive beam by using digital beam forming (for example, precoding), analog beam forming (for example, phase rotation), and so on.

The transmitting/receiving section 120 (transmission processing section 1211) may perform the processing of the Packet Data Convergence Protocol (PDCP) layer, the processing of the Radio Link Control (RLC) layer (for example, RLC retransmission control), the processing of the Medium Access Control (MAC) layer (for example, HARQ retransmission control), and so on, for example, on data and control information and so on acquired from the control section 110, and may generate bit string to transmit.

The transmitting/receiving section 120 (transmission processing section 1211) may perform transmission processing such as channel coding (which may include error correction coding), modulation, mapping, filtering, discrete Fourier transform (DFT) processing (as necessary), inverse fast Fourier transform (IFFT) processing, precoding, digital-to-analog conversion, and so on, on the bit string to transmit, and output a baseband signal.

The transmitting/receiving section 120 (RF section 122) may perform modulation to a radio frequency band, filtering, amplification, and so on, on the baseband signal, and transmit the signal of the radio frequency band through the transmitting/receiving antennas 130.

On the other hand, the transmitting/receiving section 120 (RF section 122) may perform amplification, filtering, demodulation to a baseband signal, and so on, on the signal of the radio frequency band received by the transmitting/receiving antennas 130.

The transmitting/receiving section 120 (reception processing section 1212) may apply reception processing such as analog-digital conversion, fast Fourier transform (FFT) processing, inverse discrete Fourier transform (IDFT) processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 120 (measurement section 123) may perform the measurement related to the received signal. For example, the measurement section 123 may perform Radio Resource Management (RRM) measurement, Channel State Information (CSI) measurement, and so on, based on the received signal. The measurement section 123 may measure a received power (for example, Reference Signal Received Power (RSRP)), a received quality (for example, Reference Signal Received Quality (RSRQ), a Signal to Interference plus Noise Ratio (SINR), a Signal to Noise Ratio (SNR)), a signal strength (for example, Received Signal Strength Indicator (RSSI)), channel information (for example, CSI), and so on. The measurement results may be output to the control section 110.

The transmission line interface 140 may transmit/receive (perform backhaul signaling of) a signal with an apparatus (for example, a network node providing NFs) included in the core network 30 or other base stations 10, and so on, and may acquire or transmit user data (user plane data), control plane data, and so on for the user terminal 20.

Note that the transmitting section and the receiving section of the base station 10 in the present disclosure may be constituted with at least one of the transmitting/receiving section 120, the transmitting/receiving antennas 130, and the transmission line interface 140.

Note that the transmitting/receiving section 120 may transmit, for artificial intelligence (AI)-based channel state information (CSI) feedback, configuration information for performance monitoring. The transmitting/receiving section 120 may receive a report or a model request transmitted based on the performance monitoring.

Note that the transmitting/receiving section 120 may transmit, for artificial intelligence (AI)-based channel state information (CSI) feedback, configuration information for reporting for performance monitoring. The transmitting/receiving section 120 may receive a report related to CSI measured based on the configuration information.

### User Terminal

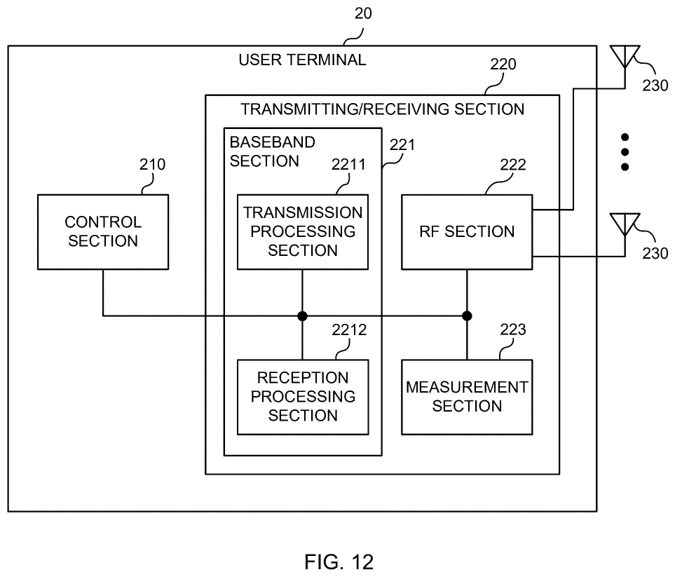

FIG. 12 is a diagram to show an example of a structure of the user terminal according to one embodiment. The user terminal 20 includes a control section 210, a transmitting/receiving section 220, and transmitting/receiving antennas 230. Note that the user terminal 20 may include one or more control sections 210, one or more transmitting/receiving sections 220, and one or more transmitting/receiving antennas 230.

Note that, the present example primarily shows functional blocks that pertain to characteristic parts of the present embodiment, and it is assumed that the user terminal 20 may include other functional blocks that are necessary for radio communication as well. Part of the processes of each section described below may be omitted.

The control section 210 controls the whole of the user terminal 20. The control section 210 can be constituted with a controller, a control circuit, or the like described based on general understanding of the technical field to which the present disclosure pertains.

The control section 210 may control generation of signals, mapping, and so on. The control section 210 may control transmission/reception, measurement and so on using the transmitting/receiving section 220, and the transmitting/receiving antennas 230. The control section 210 generates data, control information, a sequence and so on to transmit as a signal, and may forward the generated items to the transmitting/receiving section 220.

The transmitting/receiving section 220 may include a baseband section 221, an RF section 222, and a measurement section 223. The baseband section 221 may include a transmission processing section 2211 and a reception processing section 2212. The transmitting/receiving section 220 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 220 may be structured as a transmitting/receiving section in one entity, or may be constituted with a transmitting section and a receiving section. The transmitting section may be constituted with the transmission processing section 2211, and the RF section 222. The receiving section may be constituted with the reception processing section 2212, the RF section 222, and the measurement section 223.

The transmitting/receiving antennas 230 can be constituted with antennas, for example, an array antenna, or the like described based on general understanding of the technical field to which the present disclosure pertains.

The transmitting/receiving section 220 may receive the above-described downlink channel, synchronization signal, downlink reference signal, and so on. The transmitting/receiving section 220 may transmit the above-described uplink channel, uplink reference signal, and so on.

The transmitting/receiving section 220 may form at least one of a transmit beam and a receive beam by using digital beam forming (for example, precoding), analog beam forming (for example, phase rotation), and so on.

The transmitting/receiving section 220 (transmission processing section 2211) may perform the processing of the PDCP layer, the processing of the RLC layer (for example, RLC retransmission control), the processing of the MAC layer (for example, HARQ retransmission control), and so on, for example, on data and control information and so on acquired from the control section 210, and may generate bit string to transmit.

The transmitting/receiving section 220 (transmission processing section 2211) may perform transmission processing such as channel coding (which may include error correction coding), modulation, mapping, filtering, DFT processing (as necessary), IFFT processing, precoding, digital-to-analog conversion, and so on, on the bit string to transmit, and output a baseband signal.

Note that, whether to apply DFT processing or not may be based on the configuration of the transform precoding. The transmitting/receiving section 220 (transmission processing section 2211) may perform, for a certain channel (for example, PUSCH), the DFT processing as the above-described transmission processing to transmit the channel by using a DFT-s-OFDM waveform if transform precoding is enabled, and otherwise, does not need to perform the DFT processing as the above-described transmission processing.

The transmitting/receiving section 220 (RF section 222) may perform modulation to a radio frequency band, filtering, amplification, and so on, on the baseband signal, and transmit the signal of the radio frequency band through the transmitting/receiving antennas 230.

On the other hand, the transmitting/receiving section 220 (RF section 222) may perform amplification, filtering, demodulation to a baseband signal, and so on, on the signal of the radio frequency band received by the transmitting/receiving antennas 230.

The transmitting/receiving section 220 (reception processing section 2212) may apply reception processing such as analog-digital conversion, FFT processing, IDFT processing (as necessary), filtering, de-mapping, demodulation, decoding (which may include error correction decoding), MAC layer processing, the processing of the RLC layer and the processing of the PDCP layer, and so on, on the acquired baseband signal, and acquire user data and so on.

The transmitting/receiving section 220 (measurement section 223) may perform the measurement related to the received signal. For example, the measurement section 223 may perform RRM measurement, CSI measurement, and so on, based on the received signal. The measurement section 223 may measure a received power (for example, RSRP), a received quality (for example, RSRQ, SINR, SNR), a signal strength (for example, RSSI), channel information (for example, CSI), and so on. The measurement results may be output to the control section 210.

Note that the transmitting section and the receiving section of the user terminal 20 in the present disclosure may be constituted with at least one of the transmitting/receiving section 220 and the transmitting/receiving antennas 230.

Note that the transmitting/receiving section 220 may receive, for artificial intelligence (AI)-based channel state information (CSI) feedback, configuration information (for example, CSI resource configuration) for performance monitoring. The control section 210 may control the performance monitoring.

The control section 210 may monitor performance of CSI computed based on an output of an AI model, the CSI being compared with target CSI.

The control section 210 may monitor expected performance of an AI model.

The control section 210 may monitor performance of non-AI-based CSI feedback.

The transmitting/receiving section 220 may receive, for artificial intelligence (AI)-based channel state information (CSI) feedback, configuration information for reporting for performance monitoring. The control section 210 may control transmission of a report related to CSI measured based on the configuration information.

The control section 210 may include, in the report, an output obtained by inputting the CSI to an AI model.

The control section 210 may include, in the report, a precoding matrix indicator (PMI) obtained based on the CSI.

The control section 210 may include, in the report, CSI reconstructed based on a precoding matrix indicator (PMI) obtained based on the CSI.

### Hardware Structure

Note that the block diagrams that have been used to describe the above embodiments show blocks in functional units. These functional blocks (components) may be implemented in arbitrary combinations of at least one of hardware and software. Also, the method for implementing each functional block is not particularly limited. That is, each functional block may be realized by one piece of apparatus that is physically or logically coupled, or may be realized by directly or indirectly connecting two or more physically or logically separate pieces of apparatus (for example, via wire, wireless, or the like) and using these plurality of pieces of apparatus. The functional blocks may be implemented by combining software into the apparatus described above or the plurality of apparatuses described above.

Here, functions include judgment, determination, decision, calculation, computation, processing, derivation, investigation, search, confirmation, reception, transmission, output, access, resolution, selection, designation, establishment, comparison, assumption, expectation, considering, broadcasting, notifying, communicating, forwarding, configuring, reconfiguring, allocating (mapping), assigning, and the like, but function are by no means limited to these. For example, functional block (components) to implement a function of transmission may be referred to as a “transmitting section (transmitting unit),” a “transmitter,” and the like. The method for implementing each component is not particularly limited as described above.

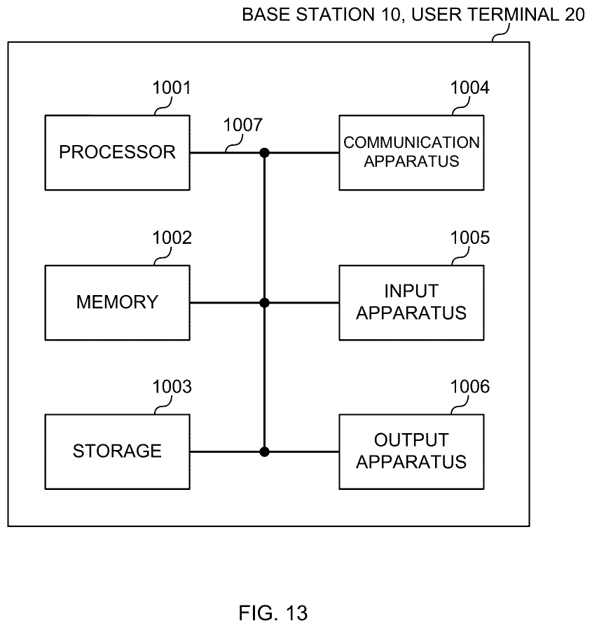

For example, a base station, a user terminal, and so on according to one embodiment of the present disclosure may function as a computer that executes the processes of the radio communication method of the present disclosure. FIG. 13 is a diagram to show an example of a hardware structure of the base station and the user terminal according to one embodiment. Physically, the above-described base station 10 and user terminal 20 may each be formed as a computer apparatus that includes a processor 1001, a memory 1002, a storage 1003, a communication apparatus 1004, an input apparatus 1005, an output apparatus 1006, a bus 1007, and so on.

Note that in the present disclosure, the words such as an apparatus, a circuit, a device, a section, a unit, and so on can be interchangeably interpreted. The hardware structure of the base station 10 and the user terminal 20 may be configured to include one or more of apparatuses shown in the drawings, or may be configured not to include part of apparatuses.

For example, although only one processor 1001 is shown, a plurality of processors may be provided. Furthermore, processes may be implemented with one processor or may be implemented at the same time, in sequence, or in different manners with two or more processors. Note that the processor 1001 may be implemented with one or more chips.

Each function of the base station 10 and the user terminals 20 is implemented, for example, by allowing certain software (programs) to be read on hardware such as the processor 1001 and the memory 1002, and by allowing the processor 1001 to perform computations to control communication via the communication apparatus 1004 and control at least one of reading and writing of data in the memory 1002 and the storage 1003.

The processor 1001 controls the whole computer by, for example, running an operating system. The processor 1001 may be configured with a central processing unit (CPU), which includes interfaces with peripheral apparatus, control apparatus, computing apparatus, a register, and so on. For example, at least part of the above-described control section 110 (210), the transmitting/receiving section 120 (220), and so on may be implemented by the processor 1001.

Furthermore, the processor 1001 reads programs (program codes), software modules, data, and so on from at least one of the storage 1003 and the communication apparatus 1004, into the memory 1002, and executes various processes according to these. As for the programs, programs to allow computers to execute at least part of the operations of the above-described embodiments are used. For example, the control section 110 (210) may be implemented by control programs that are stored in the memory 1002 and that operate on the processor 1001, and other functional blocks may be implemented likewise.

The memory 1002 is a computer-readable recording medium, and may be constituted with, for example, at least one of a Read Only Memory (ROM), an Erasable Programmable ROM (EPROM), an Electrically EPROM (EEPROM), a Random Access Memory (RAM), and other appropriate storage media. The memory 1002 may be referred to as a “register,” a “cache,” a “main memory (primary storage apparatus)” and so on. The memory 1002 can store executable programs (program codes), software modules, and the like for implementing the radio communication method according to one embodiment of the present disclosure.

The storage 1003 is a computer-readable recording medium, and may be constituted with, for example, at least one of a flexible disk, a floppy (registered trademark) disk, a magneto-optical disk (for example, a compact disc (Compact Disc ROM (CD-ROM) and so on), a digital versatile disc, a Blu-ray (registered trademark) disk), a removable disk, a hard disk drive, a smart card, a flash memory device (for example, a card, a stick, and a key drive), a magnetic stripe, a database, a server, and other appropriate storage media. The storage 1003 may be referred to as “secondary storage apparatus.”

The communication apparatus 1004 is hardware (transmitting/receiving device) for allowing inter-computer communication via at least one of wired and wireless networks, and may be referred to as, for example, a “network device,” a “network controller,” a “network card,” a “communication module,” and so on. The communication apparatus 1004 may be configured to include a high frequency switch, a duplexer, a filter, a frequency synthesizer, and so on in order to realize, for example, at least one of frequency division duplex (FDD) and time division duplex (TDD). For example, the above-described transmitting/receiving section 120 (220), the transmitting/receiving antennas 130 (230), and so on may be implemented by the communication apparatus 1004. In the transmitting/receiving section 120 (220), the transmitting section 120a (220a) and the receiving section 120b (220b) can be implemented while being separated physically or logically.

The input apparatus 1005 is an input device that receives input from the outside (for example, a keyboard, a mouse, a microphone, a switch, a button, a sensor, and so on). The output apparatus 1006 is an output device that allows sending output to the outside (for example, a display, a speaker, a Light Emitting Diode (LED) lamp, and so on). Note that the input apparatus 1005 and the output apparatus 1006 may be provided in an integrated structure (for example, a touch panel).

Furthermore, these types of apparatus, including the processor 1001, the memory 1002, and others, are connected by a bus 1007 for communicating information. The bus 1007 may be formed with a single bus, or may be formed with buses that vary between pieces of apparatus.

Also, the base station 10 and the user terminals 20 may be structured to include hardware such as a microprocessor, a digital signal processor (DSP), an Application Specific Integrated Circuit (ASIC), a Programmable Logic Device (PLD), a Field Programmable Gate Array (FPGA), and so on, and part or all of the functional blocks may be implemented by the hardware. For example, the processor 1001 may be implemented with at least one of these pieces of hardware.

### Variations

Note that the terminology described in the present disclosure and the terminology that is needed to understand the present disclosure may be replaced by other terms that convey the same or similar meanings. For example, a “channel,” a “symbol,” and a “signal” (or signaling) may be interchangeably interpreted. Also, “signals” may be “messages.” A reference signal may be abbreviated as an “RS,” and may be referred to as a “pilot,” a “pilot signal,” and so on, depending on which standard applies. Furthermore, a “component carrier (CC)” may be referred to as a “cell,” a “frequency carrier,” a “carrier frequency” and so on.

A radio frame may be constituted of one or a plurality of periods (frames) in the time domain. Each of one or a plurality of periods (frames) constituting a radio frame may be referred to as a “subframe.” Furthermore, a subframe may be constituted of one or a plurality of slots in the time domain. A subframe may be a fixed time length (for example, 1 ms) independent of numerology.

Here, numerology may be a communication parameter applied to at least one of transmission and reception of a certain signal or channel. For example, numerology may indicate at least one of a subcarrier spacing (SCS), a bandwidth, a symbol length, a cyclic prefix length, a transmission time interval (TTI), the number of symbols per TTI, a radio frame structure, a specific filter processing performed by a transceiver in the frequency domain, a specific windowing processing performed by a transceiver in the time domain, and so on.

A slot may be constituted of one or a plurality of symbols in the time domain (Orthogonal Frequency Division Multiplexing (OFDM) symbols, Single Carrier Frequency Division Multiple Access (SC-FDMA) symbols, and so on). Furthermore, a slot may be a time unit based on numerology.

A slot may include a plurality of mini-slots. Each mini-slot may be constituted of one or a plurality of symbols in the time domain. A mini-slot may be referred to as a “sub-slot.” A mini-slot may be constituted of symbols less than the number of slots. A PDSCH (or PUSCH) transmitted in a time unit larger than a mini-slot may be referred to as “PDSCH (PUSCH) mapping type A.” A PDSCH (or PUSCH) transmitted using a mini-slot may be referred to as “PDSCH (PUSCH) mapping type B.”

A radio frame, a subframe, a slot, a mini-slot, and a symbol all express time units in signal communication. A radio frame, a subframe, a slot, a mini-slot, and a symbol may each be called by other applicable terms. Note that time units such as a frame, a subframe, a slot, mini-slot, and a symbol in the present disclosure may be interchangeably interpreted.

For example, one subframe may be referred to as a “TTI,” a plurality of consecutive subframes may be referred to as a “TTI,” or one slot or one mini-slot may be referred to as a “TTI.” That is, at least one of a subframe and a TTI may be a subframe (1 ms) in existing LTE, may be a shorter period than 1 ms (for example, 1 to 13 symbols), or may be a longer period than 1 ms. Note that a unit expressing TTI may be referred to as a “slot,” a “mini-slot,” and so on instead of a “subframe.”

Here, a TTI refers to the minimum time unit of scheduling in radio communication, for example. For example, in LTE systems, a base station schedules the allocation of radio resources (such as a frequency bandwidth and transmit power that are available for each user terminal) for the user terminal in TTI units. Note that the definition of TTIs is not limited to this.

TTIs may be transmission time units for channel-encoded data packets (transport blocks), code blocks, or codewords, or may be the unit of processing in scheduling, link adaptation, and so on. Note that, when TTIs are given, the time interval (for example, the number of symbols) to which transport blocks, code blocks, codewords, or the like are actually mapped may be shorter than the TTIs.

Note that, in the case where one slot or one mini-slot is referred to as a TTI, one or more TTIs (that is, one or more slots or one or more mini-slots) may be the minimum time unit of scheduling. Furthermore, the number of slots (the number of mini-slots) constituting the minimum time unit of the scheduling may be controlled.

A TTI having a time length of 1 ms may be referred to as a “normal TTI” (TTI in 3GPP Rel. 8 to Rel. 12), a “long TTI,” a “normal subframe,” a “long subframe,” a “slot” and so on. A TTI that is shorter than a normal TTI may be referred to as a “shortened TTI,” a “short TTI,” a “partial or fractional TTI,” a “shortened subframe,” a “short subframe,” a “mini-slot,” a “sub-slot,” a “slot” and so on.

Note that a long TTI (for example, a normal TTI, a subframe, and so on) may be interpreted as a TTI having a time length exceeding 1 ms, and a short TTI (for example, a shortened TTI and so on) may be interpreted as a TTI having a TTI length shorter than the TTI length of a long TTI and equal to or longer than 1 ms.

A resource block (RB) is the unit of resource allocation in the time domain and the frequency domain, and may include one or a plurality of consecutive subcarriers in the frequency domain. The number of subcarriers included in an RB may be the same regardless of numerology, and, for example, may be 12. The number of subcarriers included in an RB may be determined based on numerology.

Also, an RB may include one or a plurality of symbols in the time domain, and may be one slot, one mini-slot, one subframe, or one TTI in length. One TTI, one subframe, and so on each may be constituted of one or a plurality of resource blocks.

Note that one or a plurality of RBs may be referred to as a “physical resource block (Physical RB (PRB)),” a “sub-carrier group (SCG),” a “resource element group (REG),”a “PRB pair,” an “RB pair” and so on.

Furthermore, a resource block may be constituted of one or a plurality of resource elements (REs). For example, one RE may correspond to a radio resource field of one subcarrier and one symbol.

A bandwidth part (BWP) (which may be referred to as a “fractional bandwidth,” and so on) may represent a subset of contiguous common resource blocks (common RBs) for certain numerology in a certain carrier. Here, a common RB may be specified by an index of the RB based on the common reference point of the carrier. A PRB may be defined by a certain BWP and may be numbered in the BWP.

The BWP may include a UL BWP (BWP for the UL) and a DL BWP (BWP for the DL). One or a plurality of BWPs may be configured in one carrier for a UE.

At least one of configured BWPs may be active, and a UE does not need to assume to transmit/receive a certain signal/channel outside active BWPs. Note that a “cell,” a “carrier,” and so on in the present disclosure may be interpreted as a “BWP.”

Note that the above-described structures of radio frames, subframes, slots, mini-slots, symbols, and so on are merely examples. For example, structures such as the number of subframes included in a radio frame, the number of slots per subframe or radio frame, the number of mini-slots included in a slot, the numbers of symbols and RBs included in a slot or a mini-slot, the number of subcarriers included in an RB, the number of symbols in a TTI, the symbol length, the cyclic prefix (CP) length, and so on can be variously changed.

Also, the information, parameters, and so on described in the present disclosure may be represented in absolute values or in relative values with respect to certain values, or may be represented in another corresponding information. For example, radio resources may be specified by certain indices.

The names used for parameters and so on in the present disclosure are in no respect limiting. Furthermore, mathematical expressions that use these parameters, and so on may be different from those expressly disclosed in the present disclosure. For example, since various channels (PUCCH, PDCCH, and so on) and information elements can be identified by any suitable names, the various names allocated to these various channels and information elements are in no respect limiting.

The information, signals, and so on described in the present disclosure may be represented by using any of a variety of different technologies. For example, data, instructions, commands, information, signals, bits, symbols, chips, and so on, all of which may be referenced throughout the herein-contained description, may be represented by voltages, currents, electromagnetic waves, magnetic fields or particles, optical fields or photons, or any combination of these.

Also, information, signals, and so on can be output in at least one of from higher layers to lower layers and from lower layers to higher layers. Information, signals, and so on may be input and/or output via a plurality of network nodes.

The information, signals, and so on that are input/output may be stored in a specific location (for example, a memory) or may be managed by using a management table. The information, signals, and so on to be input/output can be overwritten, updated, or appended. The information, signals, and so on that are output may be deleted. The information, signals, and so on that are input may be transmitted to another apparatus.

Notification of information is by no means limited to the aspects/embodiments described in the present disclosure, and other methods may be used as well. For example, notification of information in the present disclosure may be implemented by using physical layer signaling (for example, downlink control information (DCI), uplink control information (UCI)), higher layer signaling (for example, Radio Resource Control (RRC) signaling, broadcast information (master information block (MIB), system information blocks (SIBs), and so on), Medium Access Control (MAC) signaling), and other signals or combinations of these.

Note that physical layer signaling may be referred to as “Layer 1/Layer 2 (L1/L2) control information (L1/L2 control signals),” “L1 control information (L1 control signal),” and so on. Also, RRC signaling may be referred to as an “RRC message,” and can be, for example, an RRC connection setup message, an RRC connection reconfiguration message, and so on. Also, MAC signaling may be notified using, for example, MAC control elements (MAC CEs).

Also, notification of certain information (for example, notification of “X holds”) does not necessarily have to be notified explicitly, and can be notified implicitly (by, for example, not performing notification of this certain information or performing notification of another piece of information).

Determinations may be made in values represented by one bit (0 or 1), may be made in Boolean values that represent true or false, or may be made by comparing numerical values (for example, comparison against a certain value).

Software, whether referred to as “software,” “firmware,” “middleware,” “microcode,” or “hardware description language,” or called by other terms, should be interpreted broadly to mean instructions, instruction sets, code, code segments, program codes, programs, subprograms, software modules, applications, software applications, software packages, routines, subroutines, objects, executable files, execution threads, procedures, functions, and so on.

Also, software, commands, information, and so on may be transmitted and received via communication media. For example, when software is transmitted from a website, a server, or other remote sources by using at least one of wired technologies (coaxial cables, optical fiber cables, twisted-pair cables, digital subscriber lines (DSL), and so on) and wireless technologies (infrared radiation, microwaves, and so on), at least one of these wired technologies and wireless technologies are also included in the definition of communication media.

The terms “system” and “network” used in the present disclosure can be used interchangeably. The “network” may mean an apparatus (for example, a base station) included in the network.

In the present disclosure, the terms such as “precoding,” a “precoder,” a “weight (precoding weight),” “quasi-co-location (QCL),” a “Transmission Configuration Indication state (TCI state),” a “spatial relation,” a “spatial domain filter,” a “transmit power,” “phase rotation,” an “antenna port,” an “antenna port group,” a “layer,” “the number of layers,” a “rank,” a “resource,” a “resource set,” a “resource group,” a “beam,” a “beam width,” a “beam angular degree,” an “antenna,” an “antenna element,” a “panel,” and so on can be used interchangeably.

In the present disclosure, the terms such as a “base station (BS),” a “radio base station,” a “fixed station,” a “NodeB,” an “eNB (eNodeB),” a “gNB (gNodeB),” an “access point,” a “transmission point (TP),” a “reception point (RP),” a “transmission/reception point (TRP),” a “panel,” a “cell,” a “sector,” a “cell group,” a “carrier,” a “component carrier,” and so on can be used interchangeably. The base station may be referred to as the terms such as a “macro cell,” a “small cell,” a “femto cell,” a “pico cell,” and so on.

A base station can accommodate one or a plurality of (for example, three) cells. When a base station accommodates a plurality of cells, the entire coverage area of the base station can be partitioned into multiple smaller areas, and each smaller area can provide communication services through base station subsystems (for example, indoor small base stations (Remote Radio Heads (RRHs))). The term “cell” or “sector” refers to part of or the entire coverage area of at least one of a base station and a base station subsystem that provides communication services within this coverage.

In the present disclosure, a base station transmitting information to a terminal may be interchangeably interpreted as the base station indicate control/operation base on the information to the terminal.

In the present disclosure, the terms “mobile station (MS),” “user terminal,” “user equipment (UE),” and “terminal” may be used interchangeably.

A mobile station may be referred to as a “subscriber station,” “mobile unit,” “subscriber unit,” “wireless unit,” “remote unit,” “mobile device,” “wireless device,” “wireless communication device,” “remote device,” “mobile subscriber station,” “access terminal,” “mobile terminal,” “wireless terminal,” “remote terminal,” “handset,” “user agent,” “mobile client,” “client,” or some other appropriate terms in some cases.

At least one of a base station and a mobile station may be referred to as a “transmitting apparatus,” a “receiving apparatus,” a “radio communication apparatus,” and so on. Note that at least one of a base station and a mobile station may be a device mounted on a moving object or a moving object itself, and so on.

The moving object is a movable object with any moving speed, and naturally a case where the moving object is stopped is also included. Examples of the moving object include a vehicle, a transport vehicle, an automobile, a motorcycle, a bicycle, a connected car, a loading shovel, a bulldozer, a wheel loader, a dump truck, a fork lift, a train, a bus, a trolley, a rickshaw, a ship and other watercraft, an airplane, a rocket, a satellite, a drone, a multicopter, a quadcopter, a balloon, and an object mounted on any of these, but these are not restrictive. The moving object may be a moving object that autonomously travels based on a direction for moving.

The moving object may be a vehicle (for example, a car, an airplane, and the like), may be a moving object which moves unmanned (for example, a drone, an automatic operation car, and the like), or may be a robot (a manned type or unmanned type). Note that at least one of a base station and a mobile station also includes an apparatus which does not necessarily move during communication operation. For example, at least one of a base station and a mobile station may be an Internet of Things (IoT) device such as a sensor.

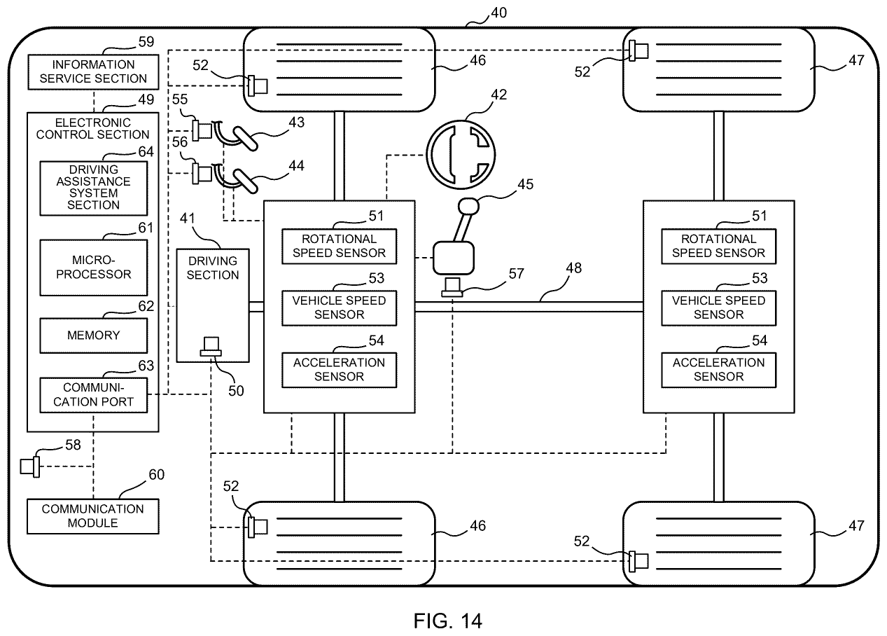

FIG. 14 is a diagram to show an example of a vehicle according to one embodiment. A vehicle 40 includes a driving section 41, a steering section 42, an accelerator pedal 43, a brake pedal 44, a shift lever 45, right and left front wheels 46, right and left rear wheels 47, an axle 48, an electronic control section 49, various sensors (including a current sensor 50, a rotational speed sensor 51, a pneumatic sensor 52, a vehicle speed sensor 53, an acceleration sensor 54, an accelerator pedal sensor 55, a brake pedal sensor 56, a shift lever sensor 57, and an object detection sensor 58), an information service section 59, and a communication module 60.

The driving section 41 includes, for example, at least one of an engine, a motor, and a hybrid of an engine and a motor. The steering section 42 at least includes a steering wheel, and is configured to steer at least one of the front wheels 46 and the rear wheels 47, based on operation of the steering wheel operated by a user.

The electronic control section 49 includes a microprocessor 61, a memory (ROM, RAM) 62, and a communication port (for example, an input/output (IO) port) 63. The electronic control section 49 receives, as input, signals from the various sensors 50 to 58 included in the vehicle. The electronic control section 49 may be referred to as an Electronic Control Unit (ECU).

Examples of the signals from the various sensors 50 to 58 include a current signal from the current sensor 50 for sensing current of a motor, a rotational speed signal of the front wheels 46/rear wheels 47 acquired by the rotational speed sensor 51, a pneumatic signal of the front wheels 46/rear wheels 47 acquired by the pneumatic sensor 52, a vehicle speed signal acquired by the vehicle speed sensor 53, an acceleration signal acquired by the acceleration sensor 54, a depressing amount signal of the accelerator pedal 43 acquired by the accelerator pedal sensor 55, a depressing amount signal of the brake pedal 44 acquired by the brake pedal sensor 56, an operation signal of the shift lever 45 acquired by the shift lever sensor 57, and a detection signal for detecting an obstruction, a vehicle, a pedestrian, and the like acquired by the object detection sensor 58.

The information service section 59 includes various devices for providing (outputting) various pieces of information such as drive information, traffic information, and entertainment information, such as a car navigation system, an audio system, a speaker, a display, a television, and a radio, and one or more ECUs that control these devices. The information service section 59 provides various pieces of information/services (for example, multimedia information/multimedia service) for an occupant of the vehicle 40, using information acquired from an external apparatus via the communication module 60 and the like.

The information service section 59 may include an input device (for example, a keyboard, a mouse, a microphone, a switch, a button, a sensor, a touch panel, and the like) for receiving input from the outside, or may include an output device (for example, a display, a speaker, an LED lamp, a touch panel, and the like) for implementing output to the outside.

A driving assistance system section 64 includes various devices for providing functions for preventing an accident and reducing a driver's driving load, such as a millimeter wave radar, Light Detection and Ranging (LiDAR), a camera, a positioning locator (for example, a Global Navigation Satellite System (GNSS) and the like), map information (for example, a high definition (HD) map, an autonomous vehicle (AV) map, and the like), a gyro system (for example, an inertial measurement apparatus (inertial measurement unit (IMU)), an inertial navigation apparatus (inertial navigation system (INS)), and the like), an artificial intelligence (AI) chip, and an AI processor, and one or more ECUs that control these devices. The driving assistance system section 64 transmits and receives various pieces of information via the communication module 60, and implements a driving assistance function or an autonomous driving function.

The communication module 60 can communicate with the microprocessor 61 and the constituent elements of the vehicle 40 via the communication port 63. For example, via the communication port 63, the communication module 60 transmits and receives data (information) to and from the driving section 41, the steering section 42, the accelerator pedal 43, the brake pedal 44, the shift lever 45, the right and left front wheels 46, the right and left rear wheels 47, the axle 48, the microprocessor 61 and the memory (ROM, RAM) 62 in the electronic control section 49, and the various sensors 50 to 58, which are included in the vehicle 40.

The communication module 60 can be controlled by the microprocessor 61 of the electronic control section 49, and is a communication device that can perform communication with an external apparatus. For example, the communication module 60 performs transmission and reception of various pieces of information to and from the external apparatus via radio communication. The communication module 60 may be either inside or outside the electronic control section 49. The external apparatus may be, for example, the base station 10, the user terminal 20, or the like described above. The communication module 60 may be, for example, at least one of the base station 10 and the user terminal 20 described above (may function as at least one of the base station 10 and the user terminal 20).

The communication module 60 may transmit at least one of signals from the various sensors 50 to 58 described above input to the electronic control section 49, information obtained based on the signals, and information based on an input from the outside (a user) obtained via the information service section 59, to the external apparatus via radio communication. The electronic control section 49, the various sensors 50 to 58, the information service section 59, and the like may be referred to as input sections that receive input. For example, the PUSCH transmitted by the communication module 60 may include information based on the input.

The communication module 60 receives various pieces of information (traffic information, signal information, inter-vehicle distance information, and the like) transmitted from the external apparatus, and displays the various pieces of information on the information service section 59 included in the vehicle. The information service section 59 may be referred to as an output section that outputs information (for example, outputs information to devices, such as a display and a speaker, based on the PDSCH received by the communication module 60 (or data/information decoded from the PDSCH)).

The communication module 60 stores the various pieces of information received from the external apparatus in the memory 62 that can be used by the microprocessor 61. Based on the pieces of information stored in the memory 62, the microprocessor 61 may perform control of the driving section 41, the steering section 42, the accelerator pedal 43, the brake pedal 44, the shift lever 45, the right and left front wheels 46, the right and left rear wheels 47, the axle 48, the various sensors 50 to 58, and the like included in the vehicle 40.

Furthermore, the base station in the present disclosure may be interpreted as a user terminal. For example, each aspect/embodiment of the present disclosure may be applied to the structure that replaces a communication between a base station and a user terminal with a communication between a plurality of user terminals (for example, which may be referred to as “Device-to-Device (D2D),” “Vehicle-to-Everything (V2X),” and the like). In this case, user terminals 20 may have the functions of the base stations 10 described above. The words such as “uplink” and “downlink” may be interpreted as the words corresponding to the terminal-to-terminal communication (for example, “sidelink”). For example, an uplink channel, a downlink channel and so on may be interpreted as a sidelink channel.

Likewise, the user terminal in the present disclosure may be interpreted as base station. In this case, the base station 10 may have the functions of the user terminal 20 described above.

Actions which have been described in the present disclosure to be performed by a base station may, in some cases, be performed by upper nodes of the base station. In a network including one or a plurality of network nodes with base stations, it is clear that various operations that are performed to communicate with terminals can be performed by base stations, one or more network nodes (for example, Mobility Management Entities (MMEs), Serving-Gateways (S-GWs), and so on may be possible, but these are not limiting) other than base stations, or combinations of these.

The aspects/embodiments illustrated in the present disclosure may be used individually or in combinations, which may be switched depending on the mode of implementation. The order of processes, sequences, flowcharts, and so on that have been used to describe the aspects/embodiments in the present disclosure may be re-ordered as long as inconsistencies do not arise. For example, although various methods have been illustrated in the present disclosure with various components of steps in exemplary orders, the specific orders that are illustrated herein are by no means limiting.

The aspects/embodiments illustrated in the present disclosure may be applied to Long Term Evolution (LTE), LTE-Advanced (LTE-A), LTE-Beyond (LTE-B), SUPER 3G, IMT-Advanced, 4th generation mobile communication system (4G), 5th generation mobile communication system (5G), 6th generation mobile communication system (6G), xth generation mobile communication system (xG, where x is, for example, an integer or a decimal), Future Radio Access (FRA), New-Radio Access Technology (RAT), New Radio (NR), New radio access (NX), Future generation radio access (FX), Global System for Mobile communications (GSM (registered trademark)), CDMA 2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), systems that use other adequate radio communication methods and next-generation systems that are enhanced based on these. A plurality of systems may be combined (for example, a combination of LTE or LTE-A and 5G, and the like) and applied.

The phrase “based on” (or “on the basis of”) as used in the present disclosure does not mean “based only on” (or “only on the basis of”), unless otherwise specified. In other words, the phrase “based on” (or “on the basis of”) means both “based only on” and “based at least on” (“only on the basis of” and “at least on the basis of”).

Reference to elements with designations such as “first,” “second,” and so on as used in the present disclosure does not generally limit the quantity or order of these elements. These designations may be used in the present disclosure only for convenience, as a method for distinguishing between two or more elements. Thus, reference to the first and second elements does not imply that only two elements may be employed, or that the first element must precede the second element in some way.

The term “judging (determining)” as in the present disclosure herein may encompass a wide variety of actions. For example, “judging (determining)” may be interpreted to mean making “judgments (determinations)” about judging, calculating, computing, processing, deriving, investigating, looking up, search and inquiry (for example, searching a table, a database, or some other data structures), ascertaining, and so on.

Furthermore, “judging (determining)” may be interpreted to mean making “judgments (determinations)” about receiving (for example, receiving information), transmitting (for example, transmitting information), input, output, accessing (for example, accessing data in a memory), and so on.

In addition, “judging (determining)” as used herein may be interpreted to mean making “judgments (determinations)” about resolving, selecting, choosing, establishing, comparing, and so on. In other words, “judging (determining)” may be interpreted to mean making “judgments (determinations)” about some action.

In addition, “judging (determining)” may be interpreted as “assuming,” “expecting,” “considering,” and the like.

“The maximum transmit power” according to the present disclosure may mean a maximum value of the transmit power, may mean the nominal maximum transmit power (the nominal UE maximum transmit power), or may mean the rated maximum transmit power (the rated UE maximum transmit power).

The terms “connected” and “coupled,” or any variation of these terms as used in the present disclosure mean all direct or indirect connections or coupling between two or more elements, and may include the presence of one or more intermediate elements between two elements that are “connected” or “coupled” to each other. The coupling or connection between the elements may be physical, logical, or a combination thereof. For example, “connection” may be interpreted as “access.”

In the present disclosure, when two elements are connected, the two elements may be considered “connected” or “coupled” to each other by using one or more electrical wires, cables and printed electrical connections, and, as some non-limiting and non-inclusive examples, by using electromagnetic energy having wavelengths in radio frequency regions, microwave regions, (both visible and invisible) optical regions, or the like.

In the present disclosure, the phrase “A and B are different” may mean that “A and B are different from each other.” Note that the phrase may mean that “A and B are each different from C.” The terms “separate,” “be coupled,” and so on may be interpreted similarly to “different.”

When terms such as “include,” “including,” and variations of these are used in the present disclosure, these terms are intended to be inclusive, in a manner similar to the way the term “comprising” is used. Furthermore, the term “or” as used in the present disclosure is intended to be not an exclusive disjunction.

For example, in the present disclosure, when an article such as “a,” “an,” and “the” in the English language is added by translation, the present disclosure may include that a noun after these articles is in a plural form.

In the present disclosure, “equal to or less than,” “less than,” “more than,” “equal to,” and the like may be interchangeably interpreted. In the present disclosure, the words meaning “good,” “bad,” “large,” “small,” “high,” “low,” “early,” “late,” and the like may be interchangeably interpreted (without distinction of positive, comparative, superlative). In the present disclosure, the words meaning “good,” “bad,” “large,” “small,” “high,” “low,” “early,” “late,” and the like may be interchangeably interpreted as expressions of those with “ith” prefixed (without distinction of positive, comparative, superlative) (for example, “highest” may be interchangeably interpreted as “ith highest”).

In the present disclosure, “of,” “for,” “regarding,” “related to,” “associated with,” and the like may be interchangeably interpreted.

Now, although the invention according to the present disclosure has been described in detail above, it should be obvious to a person skilled in the art that the invention according to the present disclosure is by no means limited to the embodiments described in the present disclosure. The invention according to the present disclosure can be implemented with various corrections and in various modifications, without departing from the spirit and scope of the invention defined by the recitations of claims. Consequently, the description of the present disclosure is provided only for the purpose of explaining examples, and should by no means be construed to limit the invention according to the present disclosure in any way.

1. A terminal comprising:
a receiving section that receives, for artificial intelligence (AI)-based channel state information (CSI) feedback, configuration information for performance monitoring; and
a control section that controls the performance monitoring.

2. The terminal according to claim 1, wherein
the control section monitors performance of CSI computed based on an output of an AI model, the CSI being compared with target CSI.

3. The terminal according to claim 1, wherein
the control section monitors expected performance of an AI model.

4. The terminal according to claim 1, wherein
the control section monitors performance of non-AI-based CSI feedback.

5. A radio communication method for a terminal, comprising:
receiving, for artificial intelligence (AI)-based channel state information (CSI) feedback, configuration information for performance monitoring; and
controlling the performance monitoring.

6. A base station comprising:
a transmitting section that transmits, for artificial intelligence (AI)-based channel state information (CSI) feedback, configuration information for performance monitoring; and
a receiving section that receives a report or a model request transmitted based on the performance monitoring.
